(19) United States
(12) Patent Application Publication
(10) Pub. No.: US 2026/0142607 A1
(43) Pub. Date: May 21, 2026

(54) Modular renewable energy generation system

(71) Applicant: PHNXX PTY LTD, Melbourne, Victoria (AU)

(72) Inventors: Benjamin Don LAM, Melbourne, Victoria (AU); Wei-Chi LEE, Melbourne, Victoria (AU); Joel He Yuan TAY, Melbourne, Victoria (AU)

(21) Appl. No.: 19/493,989

(22) PCT Filed: May 31, 2024
(86) PCT No.: PCT/AU2024/050577

§ 371 Date: Dec. 16, 2025

(30) Foreign Application Priority Data
Jun. 2, 2023 (AU) 2023901750

(51) Int. Cl. H02S 10/40; H02S 10/20; H02S 20/30; H02S 30/10; H02S 30/20

(52) U.S. Cl. CPC H02S 10/40; H02S 10/20; H02S 20/30; H02S 30/10; H02S 30/20

(57) ABSTRACT

Some embodiments relate to a modular solar power generation system. An example system includes: a transportable storage frame defining a base, a roof, opposite side walls, an interior space having an openable front portion and a back portion: a first rail and a second rail coupled to the storage frame and extending from the front portion: an electrical energy management subsystem housed in the storage frame: a plurality of solar panels frames, wherein the solar panel frames are configured to extend from the storage frame in a concertina-like configuration along the first and second rails: a plurality of solar panels coupled to each of the plurality of solar panel frames, wherein the solar panels are configured to generate energy to be stored in an energy storage system: electrical cabling for electrically coupling an electrical output from the plurality of solar panels to the electrical energy management subsystem; and a panel angle adjustment mechanism coupled to the solar panel frames for adjustment of a panel angle of the solar panel frames.

### TECHNICAL FIELD

The present disclosure relates to energy generation systems. In particular, embodiments relate to modular renewable energy generation systems.

### BACKGROUND

Renewable energy sources are being favourably viewed as alternatives for traditional fuel sources in the race to fight climate change. The largest barriers of adoption of renewable energy in remote and/or rural areas is accessibility and associated infrastructure costs (e.g. manufacturing and installation).

Existing renewable energy assets are designed to be permanent at the location at which they are installed, creating increased risk for both customers and financiers as the asset cannot be moved without great cost in the event of bankruptcy, relocation of the customer, or in preparation of a natural disaster.

The adoption of renewable energy in rural and/or remote areas is currently limited due to costs and accessibility.

It is desired to address or ameliorate one or more shortcomings or disadvantages of prior modular energy generation systems, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a modular solar power generation system. The system may include: a transportable storage frame defining a base, a roof, opposite side walls, an interior space having an openable front portion and a back portion: a first rail and a second rail coupled to the storage frame and extending from the front portion: an electrical energy management subsystem housed in the storage frame: a plurality of solar panels frames, wherein the solar panel frames are configured to extend from the storage frame in a concertina-like configuration along the first and second rails: a plurality of solar panels coupled to each of the plurality of solar panel frames, wherein the solar panels are configured to generate energy to be stored in an energy storage system: electrical cabling for electrically coupling an electrical output from the plurality of solar panels to the electrical energy management subsystem; and a panel angle adjustment mechanism coupled to the solar panel frames for adjustment of a panel angle of the solar panel frames.

The solar panels on the plurality of the solar panel frames may be electrically coupled in series. The solar panels may be electrically coupled in multiple groups. The solar panels of each group are electrically coupled in series. The multiple groups may be electrically coupled to the electrical energy management subsystem (EEMS) in parallel. Each group of solar panels may be coupled to multiple solar panel frames. Each group may include 2 to 4 solar panel frames, optionally 3 panel frames.

In some embodiments, each solar panel frame may be mechanically coupled to at least another one of the plurality of solar panel frames. Each solar panel frame may have first and second base mounting parts to slideably mount each solar panel frame on the first and second rails, respectively.

Each of the first and second base mounting parts may include a side retention flange for retaining the first and second base mounting parts on the first and second rails during sliding movement of the solar panel frames relative to the first and second rails. The first and second base mounting parts may include at least one wheel for rolling along a top surface of a respective one of the first and second rails.

In some embodiments, the system may further include an energy storage subsystem electrically coupled to the EEMS to store electrical energy received from the solar panels. The energy storage subsystem may be mounted to the base in the interior space. The EEMS may be mounted to the base or a side wall inside the interior space.

In some embodiments, a proximal portion of each of the first and second rails may extend inwardly of the storage frame. A most proximal one of the plurality of solar panel frames may be coupled to the base adjacent a proximal end of each of the first and second rails. Each of the first and second rails may have a distal end and a stopper affixed to the respective distal end to limit movement of a most distal one of the solar panel frames.

The openable front portion may include a pair of doors hinged to rotate from a closed position, in which the doors cover the front portion, to an open position, in which the doors are rotated toward the side walls and the storage frame defines a front opening. Each of the doors may have a first panel hingedly coupled to a second panel, and the second panel is hingedly coupled to a stanchion of the storage frame. The front opening may be sized to permit movement of the solar panel frames there through.

In some embodiments, the solar panel frames may be receivable in the interior space in a stowed configuration in which the solar panel frames are stacked together so that each solar panel frame is vertically orientated. The solar panel frames may define a cable slot for receiving at least part of the electrical cabling coupled to the solar panel carried by the respective solar panel frame.

Each solar panel frame may include an adjustable beam for adjustment of the panel angle of the solar panel frame. The adjustable beam may support the solar panel frame.

The first rail and the second rail may each have a length of between 50 m to 100 m. The system may have a weight of between 17,000 kg and 30,000 kg. The storage frame may have a length of between 6 m to 13 m. The storage frame may have a width of between 2 m to 3 m. The storage frame may have a height of between 2.4 m to 3.3 m.

In some embodiments, the system includes a plurality of retention mechanisms couplable to each solar panel frame and the first and second rails to limit movement of each solar panel frame with respect to the first and second rails.

### BRIEF DESCRIPTION OF DRAWINGS

Embodiments of the present disclosure will now be described by way of non-limiting example only with reference to the accompanying drawings, in which:

FIG. 1 is a schematic illustration of a modular renewable energy generation system in a disassembled configuration, according to some embodiments:

FIG. 2A is a back perspective view of a storage frame of the modular renewable energy generation system in a closed configuration, according to some embodiments:

FIG. 2B is an alternate back perspective view of a storage frame of the modular renewable energy generation system in an open configuration, according to some embodiments:

FIG. 2C is a front side perspective view of a storage frame of the modular renewable energy generation system in a closed configuration, according to some embodiments:

FIG. 2D is a front side perspective view of a storage frame of the modular renewable energy generation system in an open configuration, according to some embodiments;

FIG. 3 is a schematic illustration of a plurality of deployment rails of the modular renewable energy generation system, according to some embodiments;

FIG. 4 is a schematic illustration of a mechanism for coupling deployment rails to one another, according to some embodiments;

FIG. 5 is a schematic illustration of a mechanism for coupling a deployment rail to a storage frame of the modular renewable energy generation system, according to some embodiments;

FIG. 6 is a schematic illustration of an example solar panel frame of a solar panel array of the modular renewable energy generation system, according to some embodiments;

FIG. 7 is a schematic illustration of coupling an adjustable beam to the solar panel frame, according to some embodiments;

FIG. 8 is a schematic illustration of an adjustment beam of the solar panel frame, according to some embodiments;

FIG. 9 is a schematic illustration of a means of coupling the solar panel frame to the deployment rail, according to some embodiments;

FIG. 10 is a schematic illustration of a means of deploying the solar panel frame on the deployment rails, according to some embodiments;

FIG. 11 is an exploded view of a plurality of solar panels and the solar panel frame, according to some embodiments;

FIG. 12 is a front view of the plurality of solar panels coupled to the solar panel frame, according to some embodiments;

FIG. 13 is a front view of the plurality of solar panels coupled to an alternate solar panel frame, according to some embodiments;

FIG. 14 is a schematic illustration of a plurality of solar panels electrically coupled to an electrical energy management system, according to some embodiments;

FIGS. 15A and 15B are a schematic illustration of a plurality of solar panel groups electrically coupled to an electrical energy management system, according to some embodiments;

FIG. 16 is a schematic illustration of the solar panel array in an undeployed configuration, according to some embodiments;

FIG. 17 is a schematic illustration of the modular renewable energy generation system in a partially deployed configuration, according to some embodiments;

FIG. 18 is a schematic illustration of the modular renewable energy generation system in a deployed configuration, according to some embodiments;

FIG. 19 is a schematic illustration of an end rail of the plurality of deployment rails, according to some embodiments;

FIG. 20 is a schematic illustration of the end rail of the modular renewable energy generation system in a deployed configuration, according to some embodiments;

FIGS. 21A, 21B, and 21C are schematic illustrations of the plurality of solar panel frames in alternate angular configurations, according to some embodiments;

FIG. 22A is a schematic illustration of an example wind turbine of a wind power generation module, according to some embodiments:

FIG. 22B is a schematic illustration of the example wind turbine of FIG. 22A in a dismantled configuration, according to some embodiments:

FIG. 23 is an electrical schematic illustration of an electrical system of the modular renewable energy generation system, according to some embodiments:

FIG. 24 is a process flow diagram of a control system of the modular renewable energy generation system, according to some embodiments:

FIG. 25 is an electrical schematic illustration of an electrical system of the modular renewable energy generation system, according to some embodiments:

FIG. 26 is a schematic illustration of an alternate modular renewable energy generation system in a disassembled configuration, according to some embodiments:

FIG. 27 is a schematic illustration of the alternate modular renewable energy generation system of FIG. 26 in a partially deployed configuration, according to some embodiments:

FIG. 28 is a schematic illustration of the alternate modular renewable energy generation system of FIG. 26 in a deployed configuration, according to some embodiments:

FIG. 29 is a schematic illustration of a means of coupling the solar panel frame to the deployment rail, according to some embodiments:

FIG. 30 is a schematic illustration of a means of deploying the solar panel frame on the deployment rails, according to some embodiments;

FIG. 31 is a schematic illustration of the end rail of the modular renewable energy generation system of FIG. 26 in a deployed configuration, according to some embodiments:

FIG. 32 is a front side perspective view of a storage frame of the modular renewable energy generation system of FIG. 26 in an open configuration, according to some embodiments; and

FIG. 33 is a process flow diagram of a smart system utilising the modular renewable energy generation system of FIG. 1 or FIG. 26, according to some embodiments.

### DESCRIPTION OF EMBODIMENTS

Described embodiments of the present disclosure generally relate to renewable energy generation systems. In particular, embodiments relate to modular renewable energy generation systems. Modular renewable energy generation systems may include power generation modules, such as a solar module or a wind module, for generation of renewable electrical energy. These modules can be readily transported to a site for quick deployment. Modular renewable energy generation systems may include battery system modules for storing and controlling the generated electrical energy. The battery system modules may be readily interfaced with the power generation modules.

Multiple power generation modules may be deployed at a site and easily combined to generate larger amounts of electrical energy. Multiple battery system modules may be deployed at a site and easily combined to store larger amounts of electrical energy. Multiple power generation modules and battery system modules may be deployed at a site and easily combined to generate and store larger amounts of electrical energy.

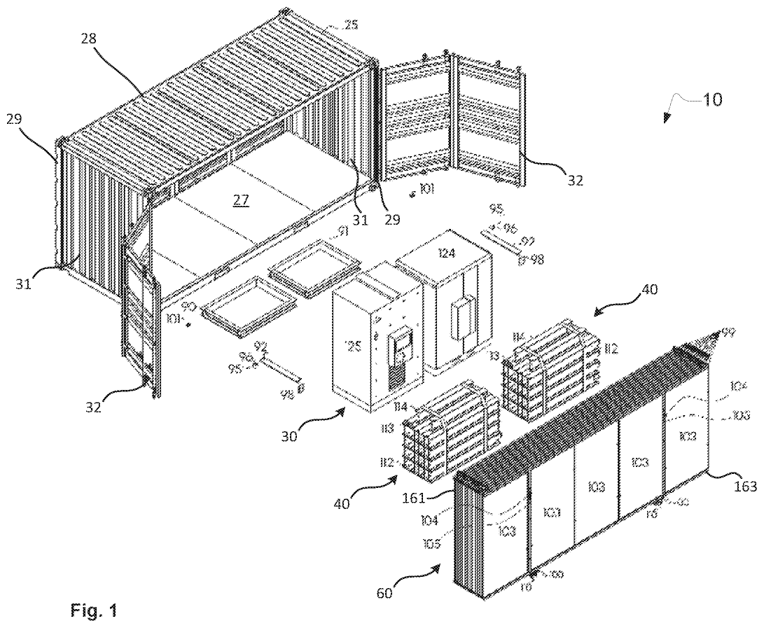

Referring to FIG. 1, there is shown a schematic illustration of a modular energy generation system 10, hereinafter referred to as an “energy system 10”, in a disassembled configuration, according to some embodiments. The energy system 10 is configured to be rapidly deployed (i.e. transported to a location and then assembled) and then later disassembled and stored for rapid re-deployment. Energy system 10 includes a storage frame 25, an electrical energy management subsystem (EEMS) 30, a plurality of deployment rails 40, and a solar panel array 60 comprising a first solar panel frame 161, plurality of solar panel frames 99, and a last solar panel frame 163. In some embodiments, each of the plurality of solar panel frames 99, 161, 163 of the solar panel array 60 is mechanically coupled to at least another one of the plurality of solar panel frames 99, 161, 163 of the solar panel array 60. The energy system 10 is configured to generate electrical energy via at least in part a plurality of solar panels 103 coupled to the plurality of solar panel frames 99.

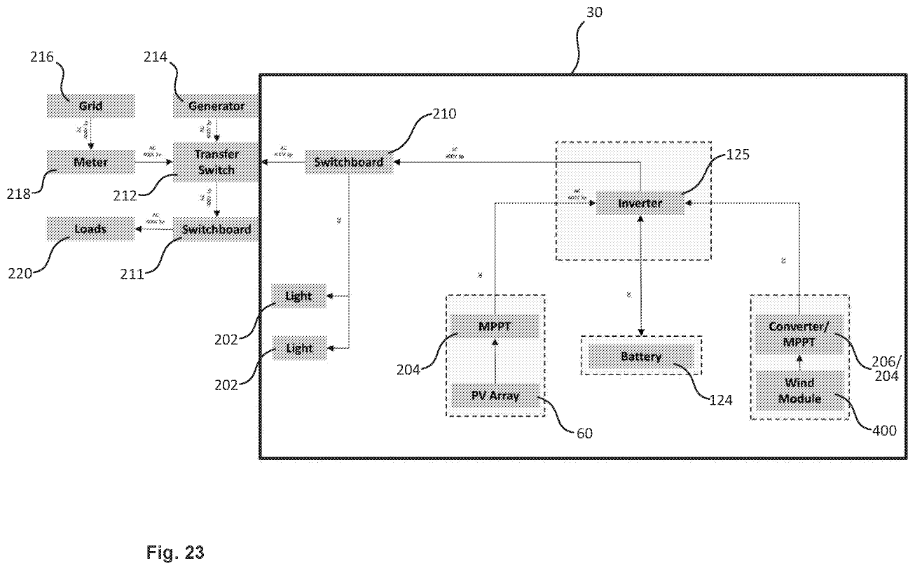

The electrical energy management subsystem 30 is configured to control and direct electrical energy generated by the plurality of solar panels 103. The EEMS 30 further comprises an inverter 125 configured to manage incoming and outgoing electrical energy. The inverter 125 may convert direct current (DC) to alternating current (AC) and vice versa, for example. The energy system 10 may be electrically coupled to an electrical grid 216 (shown in FIG. 23), wherein the EEMS 30 controls outgoing electrical energy directed to the electrical grid 216. The energy system 10 may be electrically coupled to an external battery, or batteries, wherein the EEMS 30 controls outgoing electrical energy directed to the battery, or batteries. The EMMS 30 is weatherproof, such that it can withstand exposure to environmental elements.

In some embodiments, the energy system 10 further comprises an energy storage subsystem 124 electrically coupled to the EEMS 30. The energy storage subsystem 124 is used to store electrical energy generated by the plurality of solar panels 103 for future use. For example, the generated energy may be used in a remote area where connection to a power grid, such as grid 216, is unavailable. The energy storage subsystem 124 comprises a plurality of batteries with an integrated battery management system. The batteries are configured to store electrical energy generated at least in part by the plurality of solar panels 103. The energy storage subsystem 124 is weatherproof, such that it can withstand exposure to environmental elements.

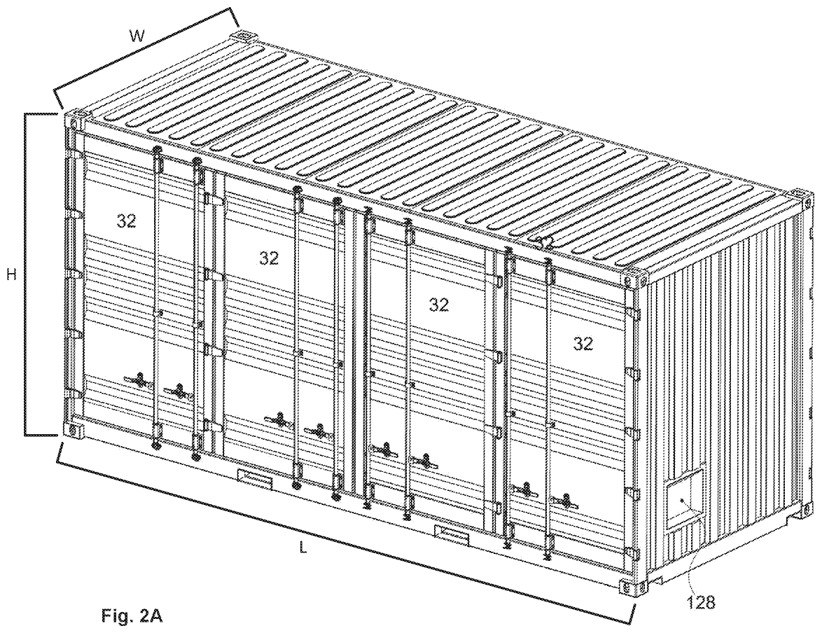

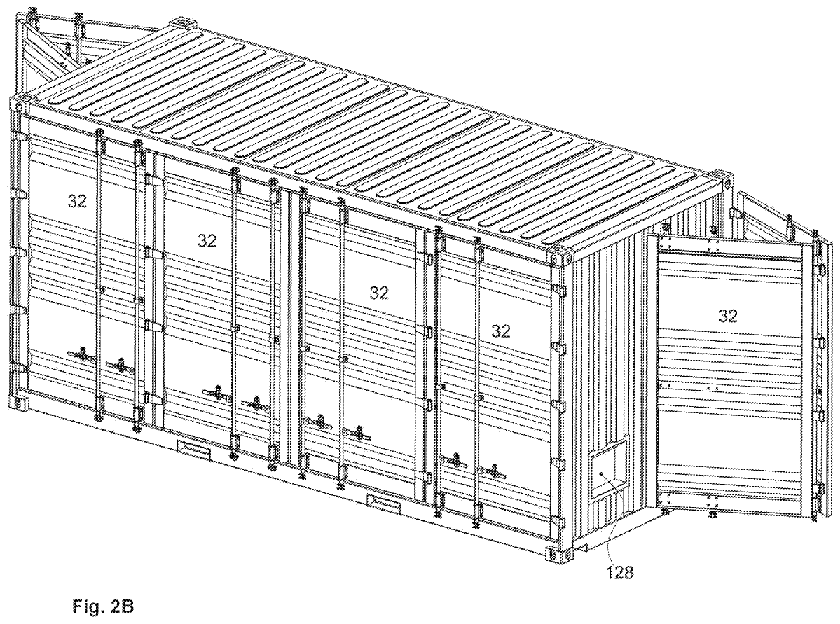

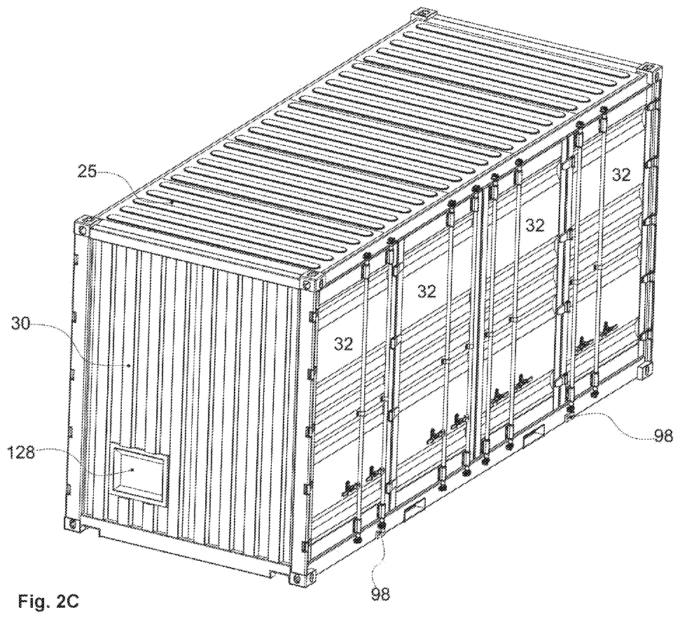

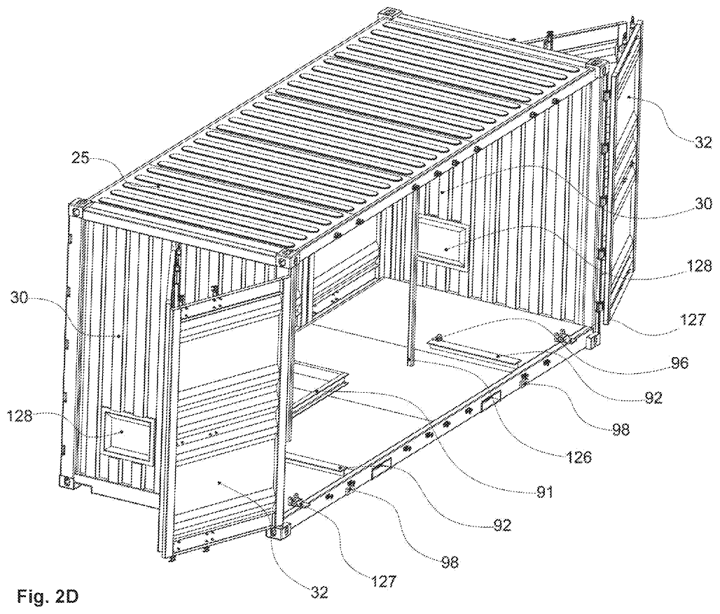

FIGS. 2A, 2B, 2C, and 2D are schematic illustrations of the storage frame 25 of the energy system 10, according to some embodiments. FIGS. 2A and 2C show the storage frame 25 in a closed configuration, wherein the storage frame 25 is in the closed configuration prior to deployment. FIGS. 2B and 2D show the storage frame 25 in an open configuration, wherein the storage frame 25 is in the open configuration during and after deployment. The storage frame 25 is configured to house the components of the energy system 10, such as the electrical energy management system 30, the plurality of deployment rails 40, and the solar panel array 60. In some embodiments, the storage frame 25 may house the components of the energy system 10 during transport and when the energy system 10 is undeployed.

In some embodiments, the storage frame 25 defines a base 27 and a roof 28, wherein the roof 28 is coupled to the base 27 via a plurality of corner stanchions 29. The storage frame 25 may include four corner stanchions 29. In some embodiments, the storage frame 25 may include additional non-corner stanchions for additional structural support. The space between the base 27, the roof 28, and each of the four corner stanchions 29 defines a side of the storage frame 25. That is, the storage frame 25 is of a substantially rectangular shape defined by the base 27, the roof 28, and the four corner stanchions 29, and includes four sides, for example. A first side of the four sides defines a front portion of the storage frame 25. A second side opposing the first side defines a back portion of the storage frame 25.

The front portion of the storage frame 25 is an openable surface, being an openable front portion, comprising doors 32, referred to hereafter as access doors 32, as shown in FIG. 1. In some embodiments, two sides of the storage frame 25 are openable surfaces, such as the front portion and the back portion. Any side of the storage frame 25 that is not an openable surface is a non-openable surface, such as walls 31. Walls 31 are opposing side walls of the storage frame 25. In the closed, or undeployed, configuration, as shown in FIGS. 2A and 2C, the base 27, the roof 28, and the four sides define a generally enclosed interior space of the storage frame 25. That is, when the access doors 32 are closed, the base 27, the roof 28, the walls 31, and the access doors 32 define a generally enclosed interior space of the storage frame 25, for example.

In some embodiments, each of the access doors 32 comprises a first door portion hingedly coupled to the storage frame 25 and a second door portion hingedly coupled to the first door portion. The first door portion may hingedly rotate outward of the interior of the storage frame 25, wherein the second door portion moves with the first door portion. The second door portion may hingedly rotate about the first door portion, irrespective of whether the first door portion is open or closed. In the open, or deployed, configuration, as shown in FIGS. 2B and 2D, the access doors 32 of the storage frame 25 open outward from the interior space of the storage frame 25. Each of the access doors 32 is securable in the open position to side mountings (not shown) on the exterior of the walls 31 of the storage frame 25. In some embodiments, the access doors 32 may be securable parallel to side mountings on the walls 31 of the storage frame 25.

In some embodiments, the access doors 32 are securable in an angled position, as shown in FIGS. 2B and 2D, allowing access to at least one panel 128. The at least one panel 128 may be mounted to any one of the walls 31 or the doors 32. The at least one panel 128 may enable electrical cabling or other equipment to pass through a wall 31 of the storage frame 25. In some embodiments, the access doors 32 are configured to be partially closeable, such that the first door portion is in the closed position and the second door portion is in the open portion. A partially closed configuration may be beneficial in limiting exposure of elements in the interior space of the storage frame 25 to the environment, for example.

In some embodiments, the storage frame 25 has a length (L), a width (W), and a height (H) as shown in FIG. 2A. Storage frame 25 may have a length between about 6 m to about 13 m. In some embodiments, storage frame 25 has a length of 6.058 m. In some embodiments, storage frame 25 has a length of 12.19 m. Storage frame 25 may have a width between about 2 m to about 3 m. In some embodiments, storage frame 25 has a width of 2.438 m. Storage frame 25 may have a height between about 2.4 m to about 3.3 m. In some embodiments, storage frame 25 has a height of 2.896 m.

In some embodiments, the storage frame 25 is a standard ISO (international organisation for standardisation) shipping container. The shipping container may be a 20-foot frame shipping container, or a 40-foot frame shipping container. The shipping container may be a standard height general purpose shipping container, or an extended height high cube shipping container. The dimensions of the various shipping container configurations are listed below:

| Configuration | Length (m) | Width (m) | Height (m) |
|---|---|---|---|
| 20-Foot General | 5.89 | 2.35 | 2.36 |
| Purpose | | | |
| 20-Foot High Cube | 5.89 | 2.35 | 2.69 |
| 40-Foot General | 12.05 | 2.35 | 2.36 |
| Purpose | | | |
| 40-Foot High Cube | 12.05 | 2.35 | 2.69 |

In some embodiments, each of the plurality of solar panel frames 99 weighs between about 350 kg to about 500 kg. Each of the plurality of solar panel frames 99 may weigh between about 400 kg and about 450 kg, for example. In some embodiments, each of the plurality of solar panel frames 99 weighs about 420 kg. In some embodiments, each of the plurality of solar panel frames 99 including five solar panels 103, respectively, weighs between about 500 kg and about 700 kg. Each of the plurality of solar panel frames 99 including five solar panels 103, respectively, may weigh between about 550 kg and about 650 kg, for example. In some embodiments, each of the plurality of solar panel frames 99 including five solar panels 103, respectively, weighs about 600 kg.

In some embodiments, the storage frame 25 weighs between about 2,230 kg to about 4,200 kg. Storage frame 25 may weigh between about 2,250 kg to about 2,500 kg, for example. In some embodiments, the storage frame 25 weighs about 4,200 kg. In some embodiments, energy system 10 weighs between about 17,000 kg and about 30,000 kg. Energy system 10 may weigh between about 17,250 kg and about 20,000 kg, for example. Energy system 10 may weigh between about 27,000 kg and about 29,500 kg, for example. In some embodiments, energy system 10 weighs about 28,750 kg.

In some embodiments, an energy system 10 including twelve to twenty six solar panel frames 99 and respective solar panels 103 weighs between about 17,000 kg to about 30,000 kg. An energy system 10 including twelve solar panel frames 99 and respective solar panels 103 may weighs between about 17,000 kg to about 19,000 kg, for example. In some embodiments, an energy system 10 including twenty six solar panel frames 99 and respective solar panels 103 weighs about 30,000 kg. In some embodiments, components of the energy system 10, such as the storage frame 25, the deployment rails 40, and or the solar panel frames 99 are manufactured using steel. The steel may be Q235 steel, for example. The steel may be Q345 steel, for example. In some embodiments, a combination of Q235 and Q345 steel may be used to manufacture energy system 10.

In some embodiments, the storage frame 25 comprises mounts 90 and 91, configured for coupling the EEMS 30 to the storage frame 25. Mounts 90 and 91 are fixedly coupled to the storage frame 25. In some embodiments, mount 90 is coupled to the base 27 of storage frame 25 inside the interior space. In some embodiments, mount 90 is coupled to one of the walls 31 of storage frame 25 inside the interior space. Mount 90 may be coupled to the storage frame 25 via a welded coupling, for example. In some embodiments, mount 91 is coupled to the base 27 of storage frame 25 inside the interior space. In some embodiments, mount 91 is coupled to one of the walls 31 of storage frame 25 inside the interior space. Mount 91 may be coupled to the storage frame 25 via a welded coupling, for example. In embodiments including the energy storage subsystem 124, the energy storage subsystem 124 of the EEMS 30 is mounted to one of the mounts 90 or 91.

Storage frame 25 further comprises at least two track beams 92 configured for coupling at least one of the plurality of solar panel frames 99 to the storage frame 25. In some embodiments, the plurality of solar panel frames 99 may non-fixedly couple to the at least two track beams 92. That is, the plurality of solar panel frames 99 may move on the at least two track beams 92, for example. The track beams 92 may be T-beams, for example. The track beams 92 are coupled to the base of the storage frame. The track beams 92 may be coupled to the base 27 via a welded coupling, for example.

Storage frame 25 further comprises at least two rail attachment plates 98 configured for coupling the plurality of deployment rails 40 to the storage frame 25. The at least two rail attachment plates 98 are coupled to the storage frame 25 such that they are aligned with the at least two track beams 92. That is, when the plurality of deployment rails 40 are coupled to the rail attachment plates 98, the deployment rails 40 and the track beams 92 are aligned, for example. In some embodiments, the storage frame 25 comprises a rail attachment plate 98 for each of track beams 92. That is, the storage frame 25 comprises an equal number of track beams 92 and rail attachment plates 98, for example.

Storage frame 25 further comprises at least one bracket 96 configured for coupling a singular solar panel frame of the plurality of solar panel frames 99 to the storage frame 25. The at least one bracket 96 may be coupled to one of the at least two track beams 92. In some embodiments, the at least one bracket 96 may fixedly couple the singular solar panel frame 99 to the storage frame 25 while allowing rotation about the coupling. In some embodiments, the storage frame 25 comprises two brackets 96, coupled to each of the at least two track beams 92.

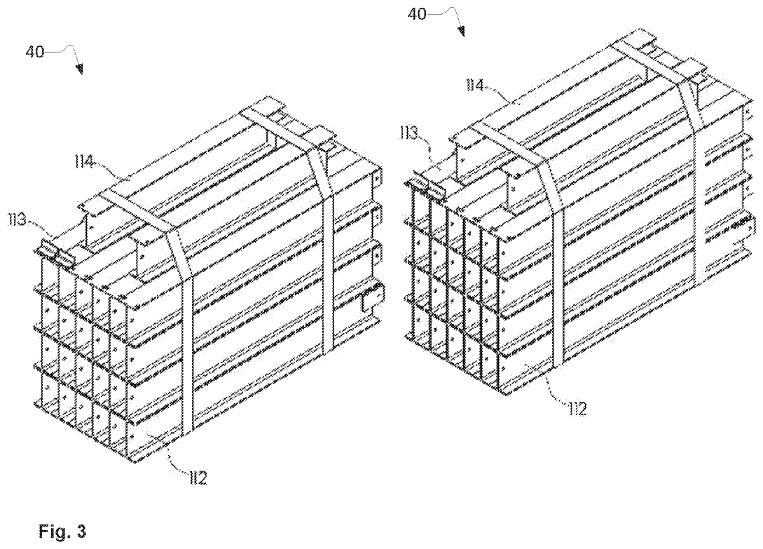

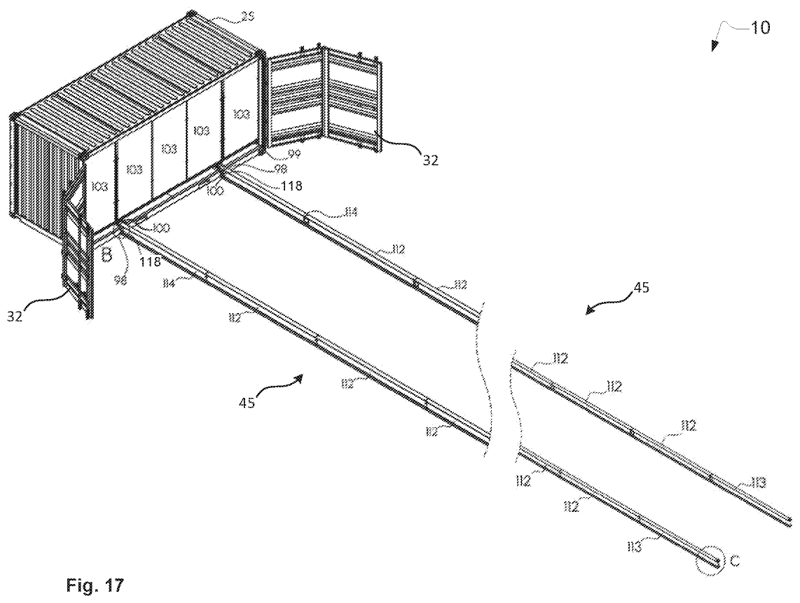

FIG. 3 shows a schematic illustration of the plurality of deployment rails 40 of the energy system 10. The plurality of deployment rails 40 comprises at least two start rails 114, at least two end rails 113, and a plurality of intermediate rails 112. The plurality of intermediate rails 112 are configured to couple to one another to form, in part, at least two composite rails 45 (as shown in FIG. 17). That is, the plurality of intermediate rails 112 are configured to couple to one another to form, in part, an extended rail 45, for example. In some embodiments, the plurality of intermediate rails 112 include an aperture 115. The aperture 115 may reduce the weight of the intermediate rails 112 whilst retaining structural integrity, for example.

Each composite rail 45 further includes a start rail 114 at a first end and an end rail 113 at a second end opposite the first end, forming a first rail 45A and a second rail 45B, respectively. That is, the composite rail 45 starts with the start rail 114 and ends with the end rail 113, for example. In some embodiments, the energy system 10 may not include intermediate rails 112, with the start rail 114 and the end rail 113 forming the composite rail 45, and the first rail 45A and the second rail 45B, respectively. The first rail 45A and the second rail 45B are configured to couple to the storage frame 25 and extend from the front portion. In some embodiments, the length of each of the first rail 45A and the second rail 45B is between about 1 m to about 100 m. The length of each of the first rail 45A and the second rail 45B may be about 50 m, for example. The length of each of the first rail 45A and the second rail 45B is substantially the same.

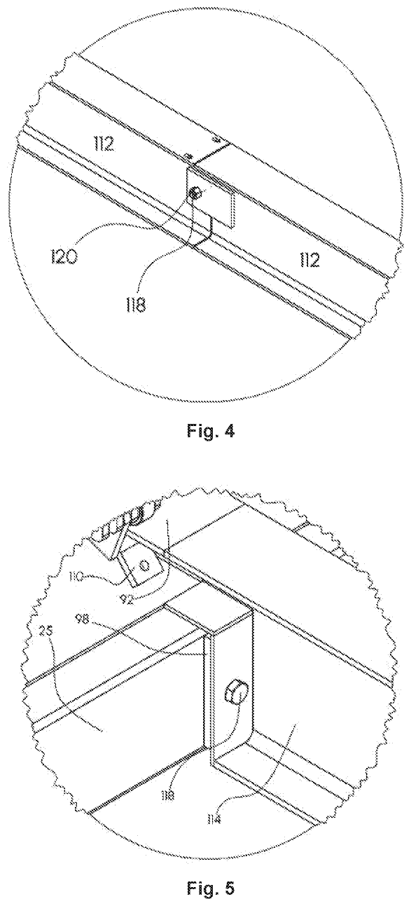

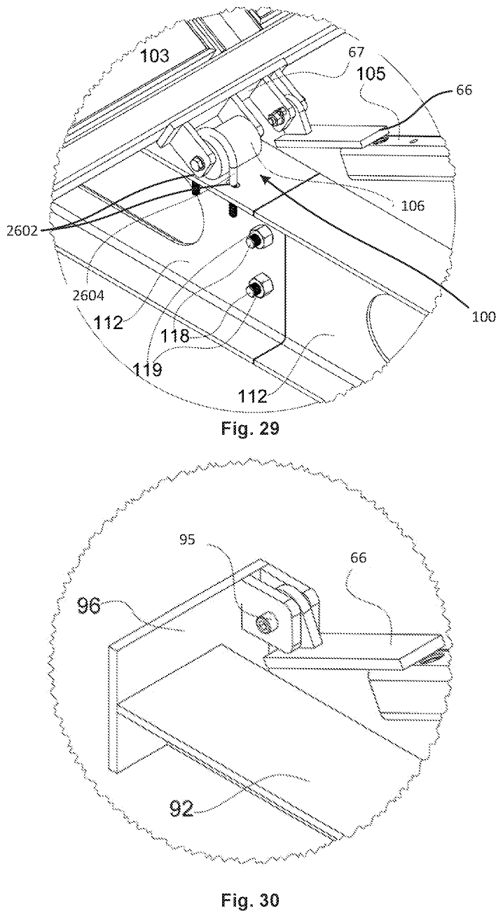

As shown in FIG. 4, any one of the start rail 114, the intermediate rails 112, or the end rail 113 may be coupled to one another via a connection bracket 120 and a bolt 118, for example. Each bolt 118 includes a respective nut, for example nut 119 as shown in FIG. 29. The start rail 114 of each composite rail 45 is configured to removably couple to a respective rail attachment plate 98 of the storage frame 25. As shown in FIG. 5, in some embodiments, the start rail 114 may be removably coupled to the attachment plate 98 via a coupling member, such as a bolt 118. In some embodiments, a proximal portion of each of the first rail 45A and the second rail 45B is configured to extend inwardly of the storage frame 25.

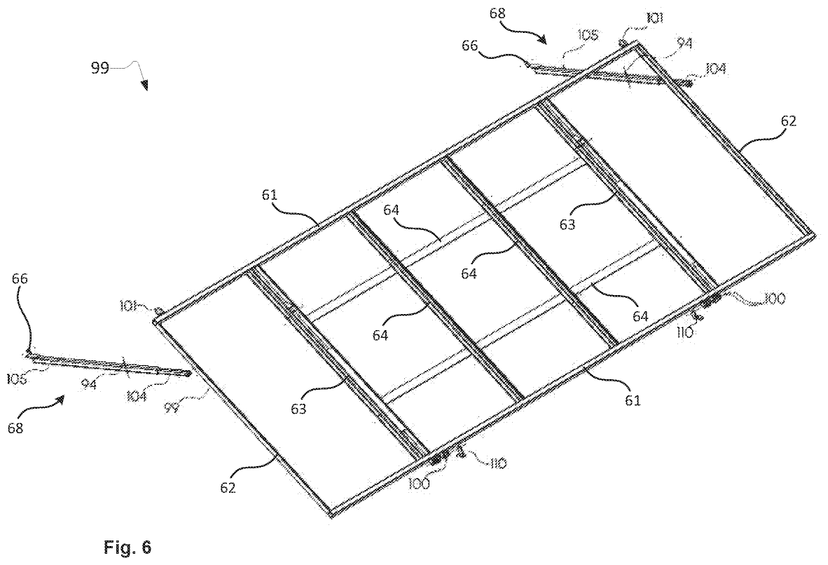

Referring to FIG. 6, there is shown a schematic illustration of an example solar panel frame 99 of the plurality of solar panel frames 99 of the energy system 10. The first solar panel frame 161 comprises a solar panel frame 99. The last solar panel frame 163 comprises a solar panel frame 99. The solar panel frame 99 comprises two first elongated portions 61 coupled to one another at respective ends via two second elongated portions 62 perpendicular to the first elongated portions 61 to form a substantially rectangular shape. That is, the ends of the first elongated portions 61 are coupled to the ends of the second elongated portions 62 to form a rectangular shape, for example. Each of the elongated portions 61 may comprise metal extrusions. The metal extrusions may be square tube extrusions, for example. The metal extrusions may be 50 mm by 50 mm, for example. The solar panel frame 99 further comprises mounting portions 63 coupled at their respective ends to each of the two first elongated portions 61 between the second elongated portions 62. In some embodiments, the mounting portions 63 are coupled equidistantly from the second elongated portions 62. The solar panel frame 99 may further comprise a plurality of supporting portions 64 to provide additional structure and strength to the solar panel frame 99.

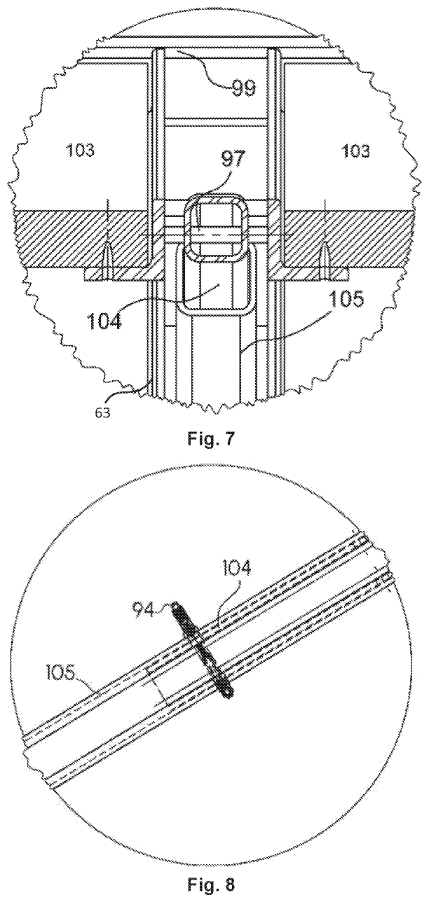

The solar panel frame 99 further comprises at least one adjustable support arm or beam 68 (shown detached in FIG. 6). The solar panel frame 99 may comprise two adjustable beams 68. The adjustable beam 68 is pivotally coupled to a mounting portion 63. In some embodiments, the mounting portions 63 comprise a recessed portion to receive the adjustable beam 68. As shown in FIG. 7, the adjustable beam 68 may be pivotally coupled to the mounting portions 63 via a pin 97.

The adjustable beam 68 comprises a first beam 104 and a second beam 105, wherein the first beam 104 is configured to sit within the second beam 105. That is, the first beam 104 may travel freely within the second beam 105 such that the length of the adjustable beam 68 may be increased or decreased, for example. The first beam 104 and the second beam 105 may have their movement relative to one another restricted by a locking pin 94, as shown in FIG. 8. That is, the length of the adjustable beam 68 may be fixed by locking the first beam 104 and the second beam 105 to one another at a particular length using the locking pin 94 passing through both the first beam 104 and the second beam 105, for example.

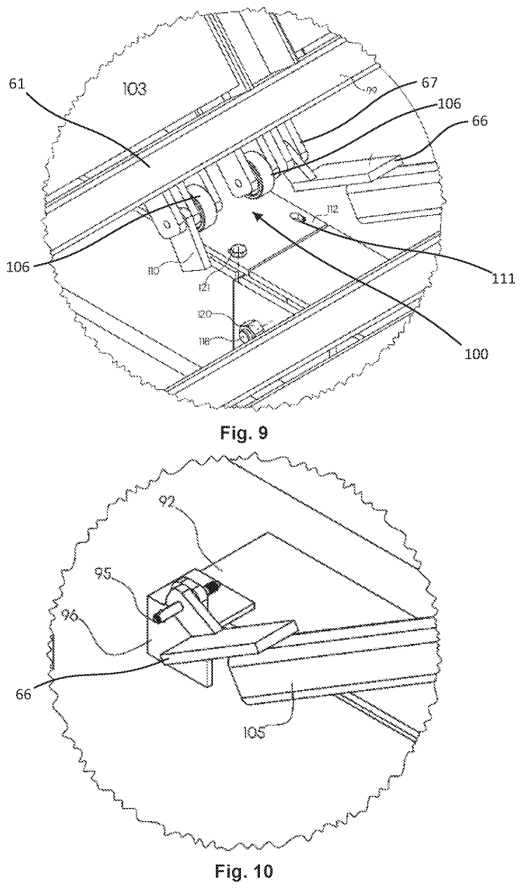

Referring back to FIG. 6, each adjustable beam 68 further comprises a connection bracket 66 coupled to the second beam 105. The connection bracket 66 may be coupled to the second beam 105 on a distal end to the first beam 104. Further shown in FIG. 9, the connection bracket 66 is configured to couple to a receiving bracket 67. The connection bracket 66 and the receiving bracket 67 are configured to rotationally couple to one another. Each solar panel frame 99 comprises at least one receiving bracket 67. Each solar panel frame 99 of the solar panel array 60 comprises a receiving bracket 67 for each adjustable beam 68. For example, if each solar panel frame 99 includes two adjustable beams 68, the solar panel frame further includes two receiving brackets 67. In some embodiments, the at least one receiving bracket 67 of each solar panel frame 99 is coupled to one of the two elongated portions 61.

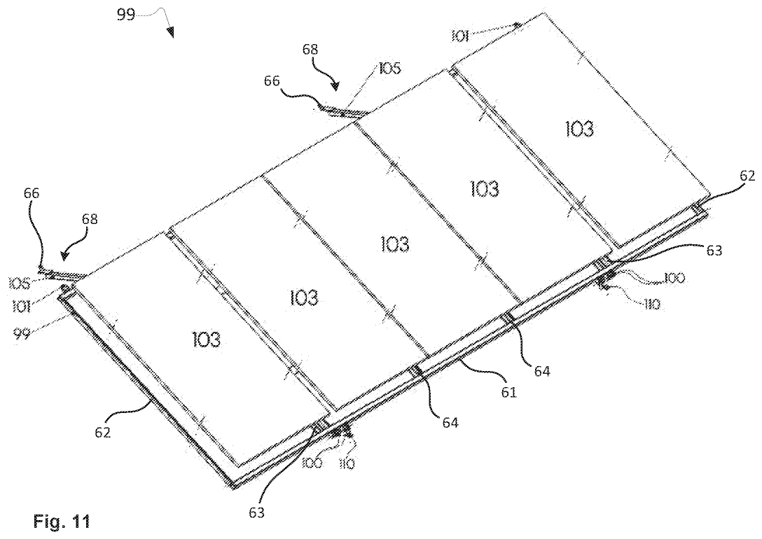

The at least one receiving bracket 67 of each solar panel frame 99 is configured to receive the connection bracket 66 of a succeeding solar panel frame 99 in the solar panel array 60. That is, each solar panel frame 99 of the solar panel array 60 is coupled to one another via the at least one connection bracket 66 and the at least one receiving bracket 67, for example. If the solar panel frame 99 is the first solar panel frame 161 in the solar panel array 60, the at least one connection bracket 66 is received by the at least one bracket 96 of the storage frame 25, as shown in FIG. 10. In some embodiments, the at least one connection bracket 66 and the at least one receiving bracket 67 and/or the at least one bracket 96 are coupled to one another via a coupling member 95, such as a locking pin.

Referring back to FIG. 6, in some embodiments, the solar panel frame 99 further comprises first and second base mounting parts 100 for slideably mounting each solar panel frame 99 on to the first rail 45A and the second rail 45B, respectively. The first and second base mounting parts 100 are coupled to one of the two first elongated portions 61 and are configured to allow the solar panel frame 99 to slideably mount to each of the first rail 45A and second rail 45B, respectively. That is, the first and second base mounting parts 100 are coupled to the elongated portion 61 configured to be nearest the first and second rails 45A, 45B, for example.

Further shown in FIG. 9, in some embodiments, each of the first and second base mounting parts 100 may include at least one wheel 106. Each of the first and second base mounting parts 100 may include 2 wheels 106, for example. The wheels 106 allow for each of the first and second base mounting parts 100 to roll along a top surface of the first and second rails 45A, 45B, respectively.

In some embodiments, each of the first and second base mounting parts 100 of the solar panel frame 99 further comprise a side retention flange 110. The side retention flange 110 is configured to retain the first and second base mounting parts 100 on the first and second rails 45A, 45B, respectively, during sliding movement of the solar panel frames 99. That is, each solar panel frame 99 is configured to be retained to the first and second rails 45A, 45B to prevent or limit lateral translational movement of the solar panel frame 99 relative to the first and second rails 45A, 45B, for example.

In some embodiments, the side retention flange 110 is mechanically fixable to any one of the start rail 114, the end rail 113, or an intermediate rail 112. Fixing the side retention flange 110 to the first or second rails 45A, 45B allows for the solar panel frame 99 to be fixed in its post-deployment position. In some embodiments, the side retention flange 110 is configured to allow pivoting of the solar panel frame 99 about the side retention flange 110. That is, an angular position of the solar panel frame 99 can be changed after the side retention flange 110 is fixed to the first or second rails 45A, 45B. The side retention flange 110 may be bolted to any one of the start rail 114, the end rail 113, or an intermediate rail 112 via a hole 111 and a bolt 121.

In some embodiments, the solar panel frame 99 further comprises at least one hook 101 configured for receiving a cable. The at least one hook 101 of each solar panel frame 99 of the solar panel array 60 is fixedly coupled to one of the two first elongated portions 61. The at least one hook 101 may be coupled to the first elongated portion 61 that does not include the wheel sets 100. The hooks 101 of each solar panel frame 99 of the solar panel array 60 are collinear to one another when the solar panel array 60 is in an undeployed configuration. That is, the hooks 101 of each solar panel frame 99 of the solar panel array 60 lie on the same straight line when the solar panel array 60 is undeployed, for example. In some embodiments, each solar panel frame 99 of the solar panel array 60 comprises two hooks 101. In embodiments including two hooks 101 for each solar panel frame 99 of the solar panel array 60, there are two collinear sets of hooks 101. That is, each of the two hooks 101 of each solar panel frame 99 is collinear to the respective hooks 101 of the other solar panel frames 99 in the solar panel array 60, for example.

The hooks 101 of each solar panel frame 99 are coupled, via an individual removable cable (not shown), to the hooks 101 of both the succeeding and preceding solar panel frames 99 in the solar panel array 60 to form a cable run. The cable run is a plurality of cables coupling to the plurality of hooks 101 that are collinear to one another. Each cable run comprises the plurality of individual cables between the first solar panel frame 161 and the last solar panel frame 163 in a collinear set. That is, each solar panel frame 99 of the solar panel array 60 is coupled to the adjacent solar panel frames 99 via the hooks 101 and a respective cable, for example. The length of each cable between the plurality of solar panels frames 99 is equal. The cables run perpendicular to the solar panel frames 99. In embodiments including two hooks 101 coupled to each solar panel frame 99, the energy system 10 includes two separate cable runs. That is, each collinear set of hooks 101 defines a path of the cable run, for example. Each cable run has the same length.

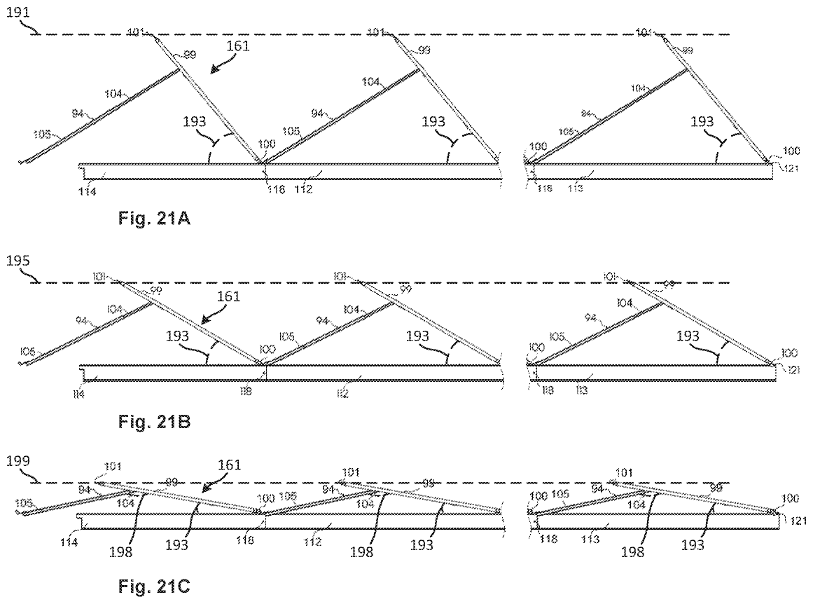

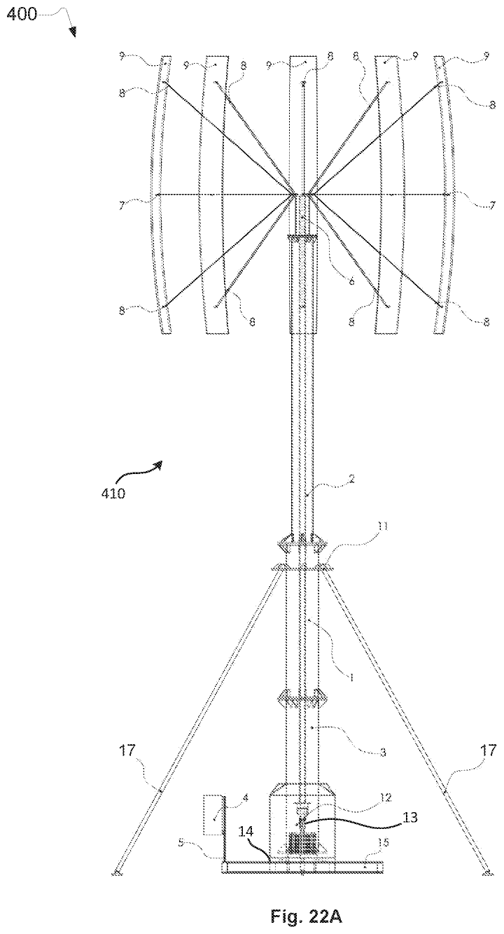

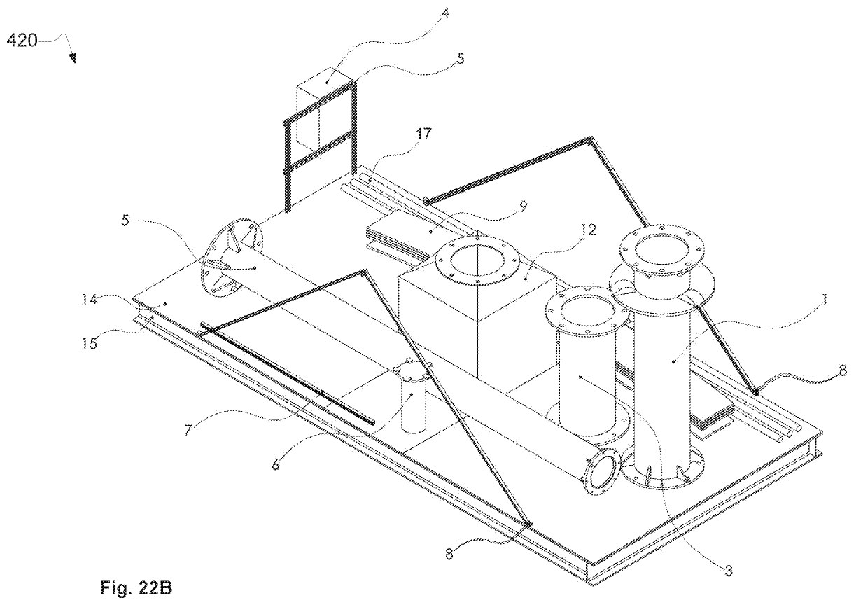

The total length of each individual cable in a cable run is no longer than the total length of the composite rails 45. That is, the sum of the length of each individual cable in a cable run is equal to or less than the length of the composite rails 45, for example. Each cable run is further coupled to the storage frame 25 via a mounting plate (not shown) coupled to the storage frame 25. The mounting plate is configured to fixedly receive at least one length of cable (not shown) from the first solar panel frame 161. That is, at least one cable may be fixedly coupled to the mounting plate from the first solar panel frame 161, for example. The at least one length of cable couples the first solar panel frame 161 to the mounting plate via the at least one hook 101 of the first solar panel frame 161. The length of the cable coupling the first solar panel frame 161 to the mounting plate may be adjusted to determine a deployment angle of the solar panel array 60, as described below in relation to FIG. 21. The cable may instead be coupled to different portions of the mounting plate to determine the deployment angle of the solar panel array 60, as described below in relation to FIG. 21. The mounting plate may be configurable to adjust the location of portions to which the cable can couple to. That is, a portion of the mounting plate to which the cable couples may be moveable to adjust where the cable couples to the mounting plate, for example.

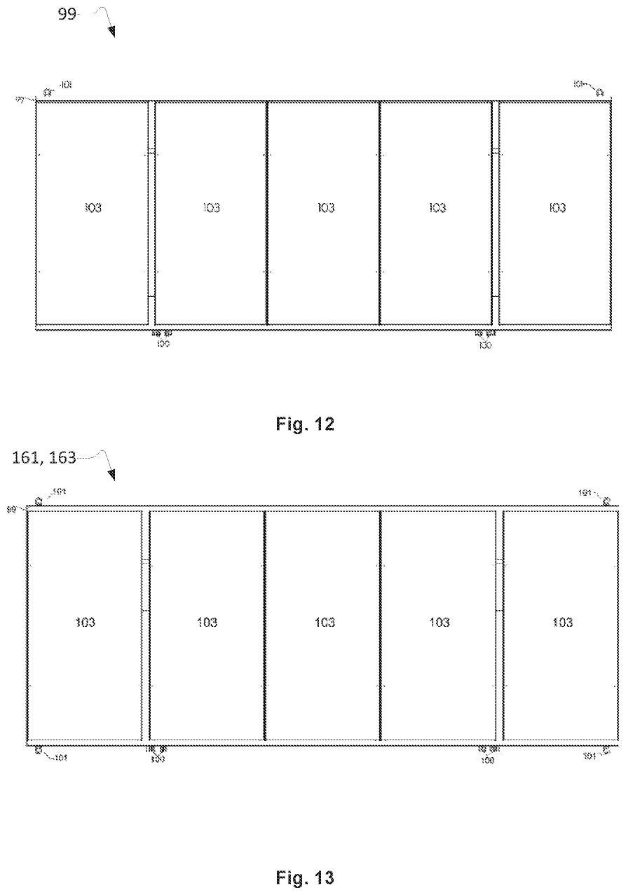

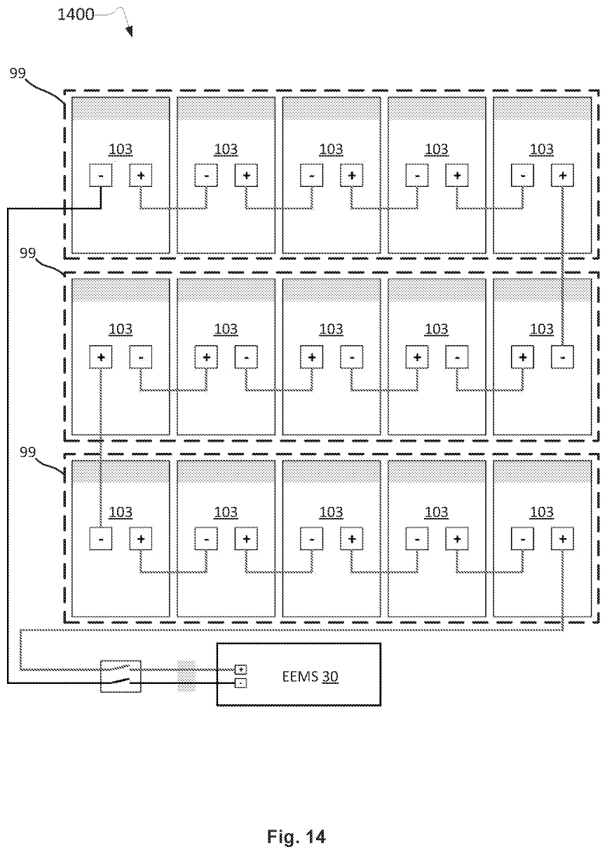

FIG. 11 is an exploded view of a plurality of solar panels 103 and the solar panel frame 99. FIG. 12 shows a front view of the plurality of solar panels 103 coupled to the solar panel frame 99. FIG. 13 shows a front view of the plurality of solar panels 103 coupled to the solar panel frame 161, 163. The plurality of solar panels 103 are fixedly coupled to the solar panel frame 99. The solar panel frame 99 may be configured to accept multiple solar panels, for example. The solar panel frame 99 may be configured to accept five solar panels, for example. The solar panel frame 99 may be configured to accept six solar panels, for example. The solar panel frame 99 may be configured to accept four solar panels, for example. The plurality of solar panels 103 are configured to convert solar energy into electrical energy. The plurality of solar panels 103 of each solar panel frame are electrically coupled to the EEMS 30. That is, the electrical energy generated by the plurality of solar panels 103 is received by the EEMS 30, for example. In some embodiments, the plurality of solar panels 103 of each solar panel frame 99 are electrically coupled in series.

Referring to FIG. 13, there is shown a front view of the plurality of solar panels 103 coupled to the last solar panel frame 163. In some embodiments, the last solar panel frame 163 further includes an additional at least two hooks 101 configured to receive a cable or coupling. The at least two additional hooks 101 provide an attachment point for an external force driver, such as a motor vehicle, to provide either a pulling or a pushing force to either deploy or retract, respectively, the solar panel array 60, for example.

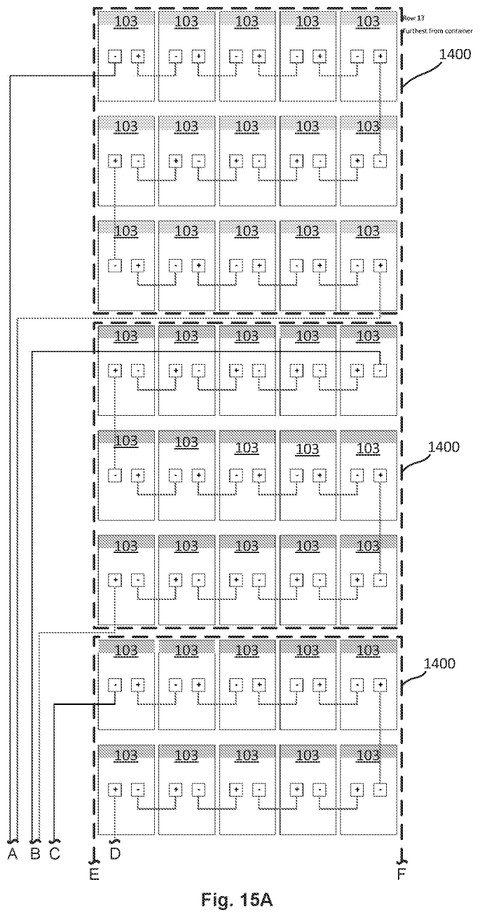

FIG. 14 is a schematic illustration of a plurality of solar panels 103 electrically coupled to the EEMS 30, according to some embodiments. The plurality of solar panels 103 are mechanically mounted or otherwise coupled to solar panel frames 99 and electrically coupled to one another. In some embodiments, the solar panels 103 of each solar panel frame 99 are electrically coupled in series. For example, five solar panels 103 are coupled to a solar panel frame 99 and electrically coupled in series. The solar panels 103 of a plurality of solar panel frames 99 may be electrically coupled to one another to form a solar panel group 1400. For example, three solar panel frames 99 comprising a total of fifteen solar panels 103 may form a single solar panel group 1400. Each solar panel group 1400 includes at least one solar panel frame 99. In some embodiments, each solar panel group 1400 includes three solar panel frames 99. The solar panel group 1400 is electrically coupled to the EEMS 30, providing generated electrical energy from solar energy to the EEMS 30.

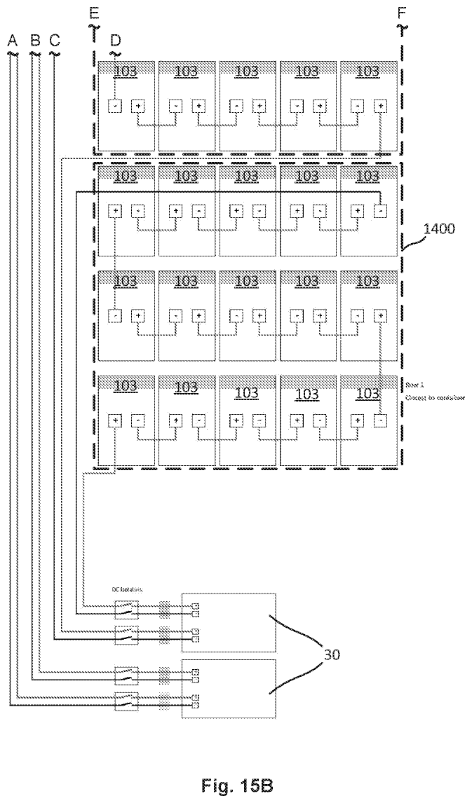

FIGS. 15A and 15B show a schematic illustration of a plurality of solar panel groups 1400 electrically coupled to the EEMS 30, according to some embodiments. FIG. 15A illustrates a first portion of the schematic diagram and FIG. 15B illustrates a second portion of the schematic diagram. Reference letters A-F indicate a continuation of a line from FIG. 15A to FIG. 15B. For example, the line of FIG. 15A marked with “A” is continued at the corresponding “A” on FIG. 15B. Similar logic also applies to each of “B” through “F” on FIGS. 15A and 15B.

As shown in FIGS. 15A and 15B, each solar panel group 1400 is electrically coupled to the EEMS 30. In some embodiments, the multiple solar panel groups 1400 are electrically coupled to the EEMS in parallel. In some embodiments, two or more solar panel groups 1400 are connected in series (not shown), forming a larger solar panel group 1400.

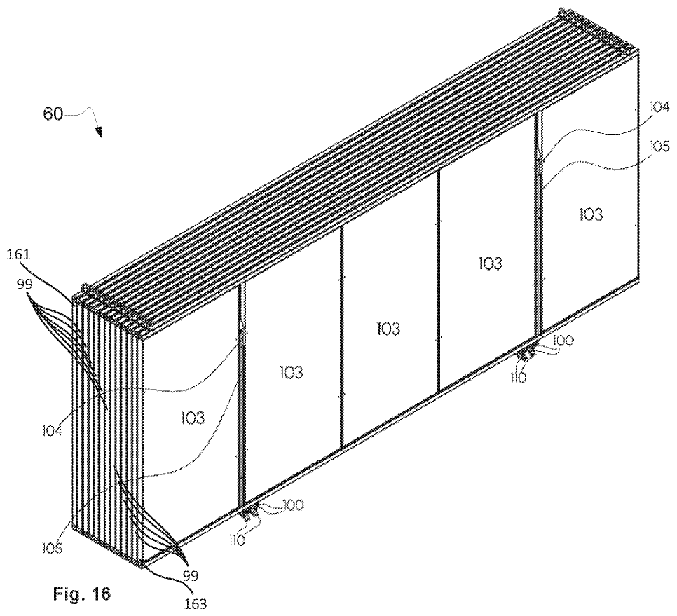

FIG. 16 is a schematic illustration of the solar panel array 60 in an undeployed or stowed configuration, according to some embodiments. The solar panel array 60 will be in the undeployed configuration when stored within the storage frame 25, such as during transportation or prior to deployment. In the undeployed configuration, the plurality of solar panel frames 99 of the solar panel array 60 are configured to be parallel to form a rectangular-like shape. In some embodiments, the plurality of solar panel frames 99 of the solar panel array 60 are further configured to be perpendicular to the base 27 of the storage frame 25. Each of the plurality of solar panel frames 99 is coupled to a succeeding solar panel frame 99 and a preceding solar panel frame 99 via their respective connection brackets 66 and receiving brackets 67, except for the first solar panel frame 161 and the last solar panel frame 163. The first solar panel frame 161 is coupled to the storage frame 25 and the succeeding solar panel frame 99. The last solar panel frame 99 is coupled to the preceding solar panel frame 99. That is, each solar panel frame 99 is coupled to the succeeding solar panel frame 99 and the preceding solar panel frame 99, while the first solar panel frame 161 in the solar panel array 60 is coupled to succeeding solar panel frame 99 and the storage frame 25 and the last solar panel frame 163 is coupled to the preceding solar panel frame 99.

Referring to FIG. 17, there is shown a schematic illustration of the energy system 10 in an example partially deployed configuration, according to some embodiments. In the example partially deployed configuration, at least two access doors 32 of the storage frame 25 are opened to allow access to components stored within the storage frame 25. The plurality of deployment rails 40 are configured to extend from the storage frame 25 to form the two composite rails 45 as previously described in relation to FIGS. 3 and 4. The composite rails 45 are coupled to the storage frame 25 as previously described in relation to FIG. 5.

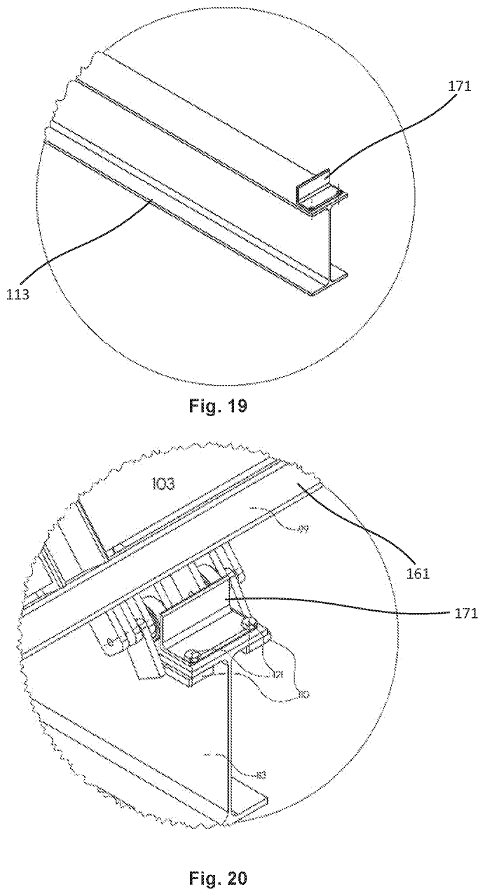

Referring to FIGS. 19 and 20, there is shown a schematic illustration of end rail 113 of the plurality of deployment rails, according to some embodiments. FIG. 19 is an enlarged view of section C of FIG. 17. Each end rail 113 includes a stopper 171 configured to prevent or limit translational movement of the solar panel array 60 further than the composite rails 45. That is, stopper 171 prevents or limits the solar panel array 60 from rolling, via the wheel sets 100, off of the composite rails 45, as shown in FIG. 20, for example.

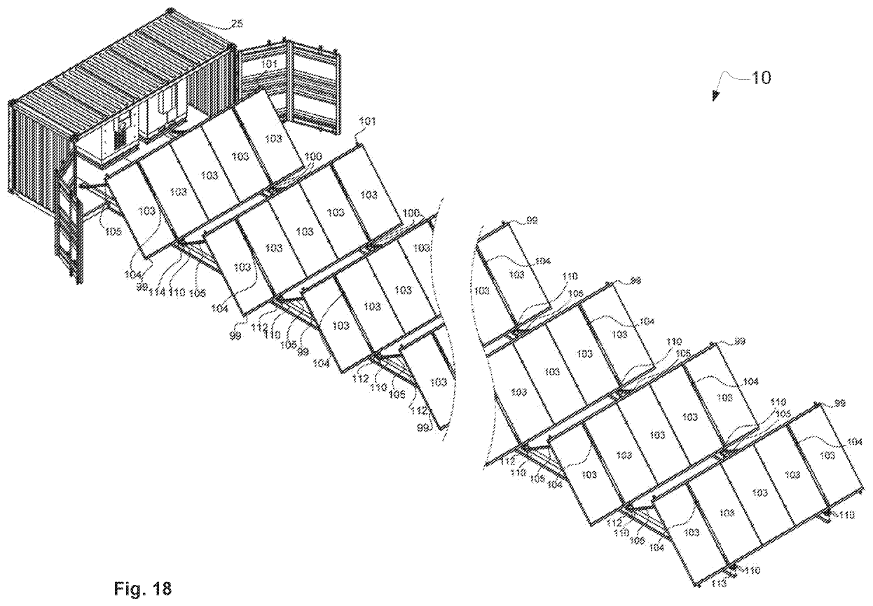

FIG. 18 shows a schematic illustration of the energy system 10 in an example deployed configuration, according to some embodiments. In the example deployed configuration, the example partially deployed configuration is further configured to such that the solar panel array 60 is deployed. That is, the access doors 32 of the storage frame 25 are open, the composite rails 45 are deployed and coupled to the storage frame 25, and the solar panel array 60 is deployed. To deploy the solar panel array 60, an external pulling force, such as a tractor, may be attached to the at least two hooks 101 of the last solar panel frame 163.

The external pulling force is then applied, pulling the last solar panel frame 163 along the composite rails via the wheel sets 100. Due to the coupling of each solar panel frame 99 to at least one adjacent solar panel frame 99 in the solar panel array 60 via the adjustable beams 68, the pulling of the last solar panel frame 163 further pulls the next solar panel frame 99 in the solar panel array 60. In embodiments including cables coupling adjacent solar panel frames 99 in the solar panel array 60, the cables additionally assist in pulling preceding solar panel frames 99 in the solar panel array 60. This produces an effect where each solar panel frame 99 pulls the preceding solar panel frame 99 in the solar panel array 60 along the composite rails 45. The external pulling force is applied until the last solar panel frame 161 contacts each stopper 171 of the composite rails 45, preventing or limiting the last solar panel frame 161 from decoupling the composite rails 45, as shown in FIG. 20.

In embodiments including cables coupling adjacent solar panel frames 99 in the solar panel array 60, the cables may restrict the translational movement of the solar panel frames 99 along the composite rails 45. That is, when each individual cable coupling the solar panel frames 99 of the solar panel array 60 is pulled taught, the solar panel array 60 has its movement restricted, for example. When the cables are taught, they are generally parallel to the composite rails 45. In some embodiments, the cables may further determine the angle of deployment of the solar panel array 60 via the cable coupling the first solar panel frame 161 to the mounting plate. The angle of deployment may be determined prior to deploying the solar panel array 60.

As shown in FIG. 18, the plurality of solar panel frames 99, 161, and 163 are approximately parallel to one another in the deployed configuration. That is, the plurality of solar panels 103 of the solar panel array 60 face substantially the same direction when the energy system 10 is deployed, for example.

Referring to FIGS. 21A, 21B, and 21C are schematic illustrations of the plurality of solar panel frames 99 in alternate angular configurations, being 55 degrees, 30 degrees, and 10 degrees, respectively, according to some embodiments. In embodiments where the length of the cable is adjusted to determine a deployment angle 193, or panel angle 193, the cable is coupled to the mounting plate at a particular length to restrict the maximum movement of the first solar panel 161. For example, as shown in FIG. 21A, the cable may be of a length to prevent or limit the at least one hook 101 of the first solar panel frame 161 from moving below the horizontal line 191 indicating a deployment angle 193 of 55 degrees. The succeeding solar panel frames 99 have their movement restricted due to the cables coupling the solar panel frames of the solar panel array 60, preventing or limiting movement of each solar panel frame of the solar panel array 60 below the horizontal line 191 as the cables are pulled taught. Similarly, referring to FIGS. 21B and 21C, the cable may be of a length to prevent or limit the at least one hook 101 of the first solar panel frame 161 from moving below the horizontal lines 195, 199 indicating deployment angle 193 of 30 degrees and 10 degrees, respectively.

In embodiments where the cable is coupled to different portions of the mounting plate to determine the angle of deployment, the cable is coupled to the mounting plate at a particular point to restrict the maximum movement of the first solar panel 161. For example, as shown in FIG. 21A, the cable may be coupled to a portion of the mounting plate to prevent or limit the at least one hook 101 of the first solar panel frame 161 from moving below the horizontal line 191 indicating a deployment angle 193 of 55 degrees. The succeeding solar panel frames 99 have their movement restricted due to the cables coupling the solar panel frames of the solar panel array 60, preventing or limiting movement of each solar panel frame of the solar panel array 60 below the horizontal line 191 as the cables are pulled taught. Similarly, referring to FIGS. 21B and 21C, the cable may be coupled to different portions of the mounting plate to prevent or limit the at least one hook 101 of the first solar panel frame 161 from moving below the horizontal lines 195 or 199 indicating deployment angles 193 of 30 degrees and 10 degrees, respectively.

In some embodiments, the adjustable beams 68 are coupled to the mounting portion 63 to prevent or limit pivoting of the adjustable beams 68 about the mounting portion 63 beyond a maximum angle 198 such that the minimum deployment angle 193 is 10 degrees, as shown in FIG. 21C. That is, the minimum deployment angle 193 of the solar panel array 60 is 10 degrees, for example.

Upon deployment of the solar panel array 60, each of the adjustable beams 68 may be locked at the desired length, via locking pin 94, to fix the deployment angle 193. Each of the locking brackets 110 may then be fixedly coupled to the plurality of deployment rails 40 to further prevent or limit translational movement of the solar panel array 60. The locking brackets 110 may be fixedly coupled to the plurality of deployment rails 40 prior to locking the adjustable beams 68 at their desired length. Once movement of the solar panel array 60 is fixed, the cables may be removed from their respective hooks. The length of the adjustable beams 68 may be adjusted after deployment to individually adjust the angle of deployment of each solar panel frame of the solar panel array 60.

In some embodiments, energy system 10 further comprises a wind module 400 comprising a wind turbine, such as wind turbine 410 shown in FIGS. 22A and 22B. In some embodiments, energy system 10 comprises a plurality of wind modules 400. Referring to FIG. 22A, there is shown a schematic illustration of an example wind turbine 410 of a wind power generation module, according to some embodiments. The wind turbine 410 may be a suitable off-the-shelf vertical or horizontal wind turbine including at least 3 blades or vanes, for example. Wind turbine 410 comprises a plurality of blades 9 coupled to a central shaft 6 via a plurality of horizontal supporting arms 7 and angled supporting arms 8. Rotation of the plurality of blades 9 about the central shaft 6 caused by wind results in rotation of the central shaft 6, for example. The central shaft 6 is rotatably mounted within a first supporting shaft 1, a second supporting shaft 2, and a third supporting shaft 3, such that the central shaft 6 can rotate within each of the first supporting shaft 1, the second supporting shaft 2, and the third supporting shaft 3.

The first, second, and third supporting shafts 1, 2, 3 are fixedly coupled to one another. The second supporting shaft 2 may have a smaller radius than the first and third supporting shafts 1, 3, for example. The third supporting shaft 3 is fixedly coupled to a base structure 15, wherein the base structure 15 provides a base support for the wind turbine 410. Wind turbine 410 further comprises at least three supporting struts 17 coupled to any one of the first, second, or third supporting shafts 1, 2, 3. The at least three supporting struts 17 are configured to fixedly couple any one of the first, second, or third supporting shafts 1, 2, 3 to an external fixed point, such as the ground or a mounting structure (not shown), to provide structural stability to the wind turbine 410.

Wind turbine 410 further comprises a generator 12, configured to receive the rotatable central shaft 6 via a connecting portion 13. The generator 12 is electrically coupled to the EEMS 30. As the central shaft 6 is rotated due to wind forces on the plurality of blades 9, the generator 12 converts rotational energy generated by the central shaft 6 into electrical energy to be electrically transferred to the EEMS 30. The generator 12 further comprises a base plate 14 for fixedly coupling the generator 12 to the base structure 15. In some embodiments, the base plate 14 may form part of the base structure 15. In some embodiments, wind turbine 410 further includes a control box 4 coupled to the base structure 15 via an arm 5. The control box 4 may provide a user access to control equipment and diagnostic information of the wind turbine 410, for example. In some embodiments, the base structure 15 may mechanically couple to the roof of the storage frame 25.

Referring to FIG. 22B, there is shown a schematic illustration of a wind turbine kit 420, wherein the wind turbine kit 420 is the example wind turbine 410 in a dismantled configuration, according to some embodiments. As shown in FIG. 23B, during transportation of the wind turbine kit 420, the base structure 15 provides a means of carrying all of the components of the wind turbine kit 420. In some embodiments, the generator 12 is fixedly coupled to the base structure 15 during manufacture.

FIG. 23 is an electrical schematic illustration of the EEMS 30 of the energy system 10, according to some embodiments. EEMS 30 comprises at least one solar panel array 60 electrical coupled to a maximum power point tracking module (MPPT) 204. The MPPT 204 may be a charge controller provided to maximise the output of the solar panel array 60, for example. In some embodiments, each of the at least one solar panel array 60 has an individual respective MPPT 204. The MPPT 204 is electrically coupled to an inverter 125, wherein the MPPT 204 provides DC electricity to the inverter 125 to be converted to AC electricity. The inverter 125 converts DC electricity input and outputs AC electricity in line with the AC electricity used by the grid 216. This allows for the energy system 10 to be easily connected to the grid 216 at any location. In some embodiments, the grid 216 utilises 3-phase 400V AC electricity.

In some embodiments, EEMS 30 further comprises wind module 400 electrically coupled to an MPPT 204 and a converter 206. The MPPT 204 and the converter 206 are electrically coupled to the inverter 125. The MPPT 204 may be a charge controller provided to maximise the output of the wind module 400, for example. The wind module 400 produces AC electricity that is not in line with the AC electricity of the grid 216. Converter 206 converts the AC electricity generated by wind module 400 to DC electricity to then be inverted, by inverter 125, to AC electricity in line with the AC electricity used by the grid 216. In some embodiments, EEMS 30 further comprises energy storage subsystem 124, for storing electrical energy generated by the solar panel array 60 and/or the wind module 400.

Inverter 125 outputs AC electricity to a first switchboard 210, wherein the first switchboard 210 is configured to divide received AC electricity from the inverter 125 into branch circuits. That is, the first switchboard 210 distributes AC electricity received from the inverter 125, for example. In some embodiments, the first switchboard 210 includes a plurality of protective circuit breakers or fuse for each connected circuit. In some embodiments, the first switchboard 210 outputs electricity to circuits and components of energy system 10, such as lights 202, for example.

The first switchboard 210 further outputs AC electricity to a transfer switch 212 external to the energy system 10. Transfer switch 212 allows the safe connection or disconnection energy system 10 of electricity to an electric load. Transfer switch 212 may manage electrical input from a plurality of electrical sources, such as energy system 10, generator 214, and grid 216 via meter 218, for example. Transfer switch 212 may further output received electrical energy to a second switchboard 211 for distribution to loads 220.

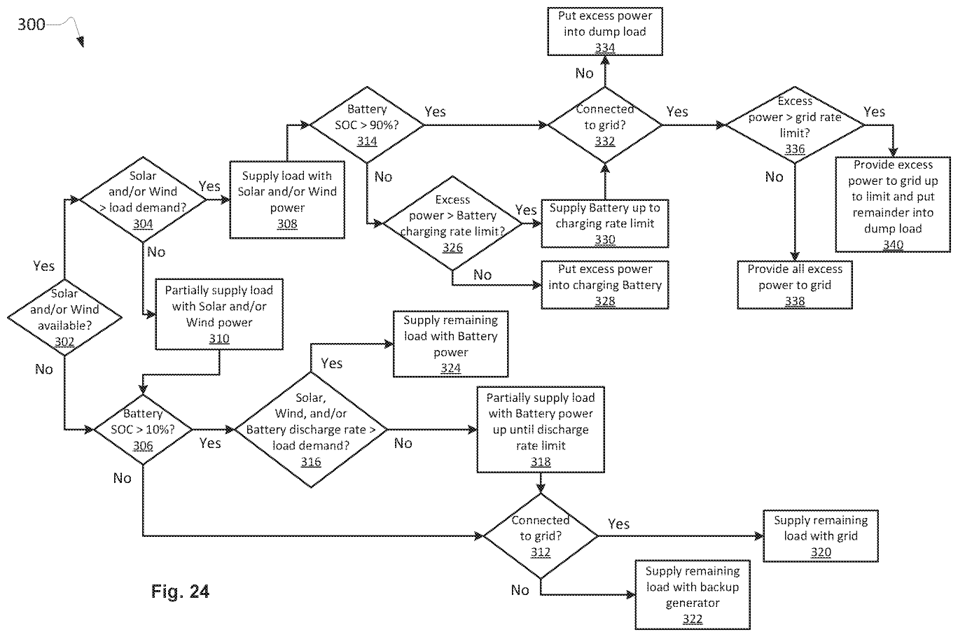

FIG. 24 is a process flow diagram of a control system 300 of the EEMS 30, according to some embodiments. Control system 300 generally outlines a decision tree of the EEMS 30 of the energy system 10 including the solar panel array, at least one wind module 400, and the energy storage subsystem 124. At step 302, the EEMS 30 determines whether solar and/or wind electrical energy, from the solar panel array 60 and/or the wind module 400, respectively, is available. If available, control system 300 proceeds to step 304, if unavailable, control system 300 proceeds to step 306.

At step 306, control system 300 determines whether the battery, or batteries, of the energy storage subsystem 124 have a state of charge greater than 10%. If the state of charge is less than 10%, control system 300 proceeds to step 312. If the state of charge is greater than 10%, control system 300 proceeds to step 316. At step 316, control system 300 determines whether the demand of loads electrically coupled to energy system 10 exceeds the discharge rate of energy system 10, wherein the discharge rate is the supply capacity of the solar panel array 60, the wind module 400, and the energy storage subsystem 124. If the load demand is less than the discharge rate, control system 300 proceeds to step 324. At step 324, energy system 10 supplies the load demand with electrically energy stored in the battery, or batteries, of the energy storage subsystem 124. That is, electrical energy generated by the solar panel array 60 and/or the wind module 400 is stored in the energy storage subsystem 124, which supplies the load demand, for example.

If the load demand is greater than the discharge rate, control system 300 proceeds to step 318. At step 318, control system 10 partially supplies the load demand with electrically energy stored in the battery, or batteries, of the energy storage subsystem 124 until the discharge rate limit is reached. That is, energy stored in the battery will be used in combination with electrical energy generated by the solar panel array 60 and/or the wind module 400 to meet load demand, for example. Control system 300, while partially supplying the load demand proceeds to step 312. At step 312, control system 300 determines whether the energy system 10 is connected to the grid 216. If energy system 10 is connected to the grid 216, control system 300 proceeds to step 320, wherein the control system 300 supplies the remaining load demand with electrical energy supplied by the grid 216. If energy system 10 is not connected to the grid 216, control system 300 proceeds to step 322, wherein the control system 300 supplies the remaining load demand with electrical energy supplied by generator 214.

At step 304, control system 300 determines if the solar and/or wind electrical energy generation, from the solar panel array 60 and/or the wind module 400, respectively, is greater than the load demand. If load demand is greater, control system 300 proceeds to step 310, if load demand is less, control system proceeds to step 308. At step 310, control system 300 partially supplies the load with solar and/or wind electrical energy and proceeds to step 306, as previously described. At step 308, control system 300 supplies the load with solar and/or wind electrical energy and proceeds to step 314.

At step 314, control system 300 determines whether the battery, or batteries, of the energy storage subsystem 124 have a state of charge greater than 90%. If the state of charge is less than 90%, control system 300 proceeds to step 326. If the state of charge is greater than 90%, control system 300 proceeds to step 332. At step 326, control system 300 determines whether electrical energy generated by the solar panel array 60 and/or wind module 400 in excess of the load demand is greater than the battery charging rate limit. If excess power is less than the battery charging rate limit, control system 300 proceeds to step 324, wherein the control system 300 puts the excess power towards charging the battery. If excess power is greater than the battery charging rate limit, control system 300 proceeds to step 330, wherein the control system 300 puts the excess power towards charging the battery up to the charging rate limit. After performing step 330, control system 300 proceeds to step 332.

At step 332, control system 300 determines whether the energy system 10 is connected to the grid 216. If energy system 10 is not connected to the grid 216, control system 300 proceeds to step 334, wherein the control system 300 puts excess power into a dump load. The dump load is used when batteries are determined to be at full charge to divert excess power being generated to a separate load (dump load) rather than overloading the batteries. If energy system 10 is connected to the grid 216, control system 300 proceeds to step 336.

At step 336, the control system 300 determines whether the excess power is greater than the grid 216 rate limit. If the excess power is greater than the grid 216 rate limit, the control system 300 will provide the excess power to the grid 216 up to the grid 216 rate limit. Any excess power above the grid 216 rate limit is put into the dump load. If excess power is less than the grid 216 rate limit, the control system 300 will provide all of the excess power to the grid 216.

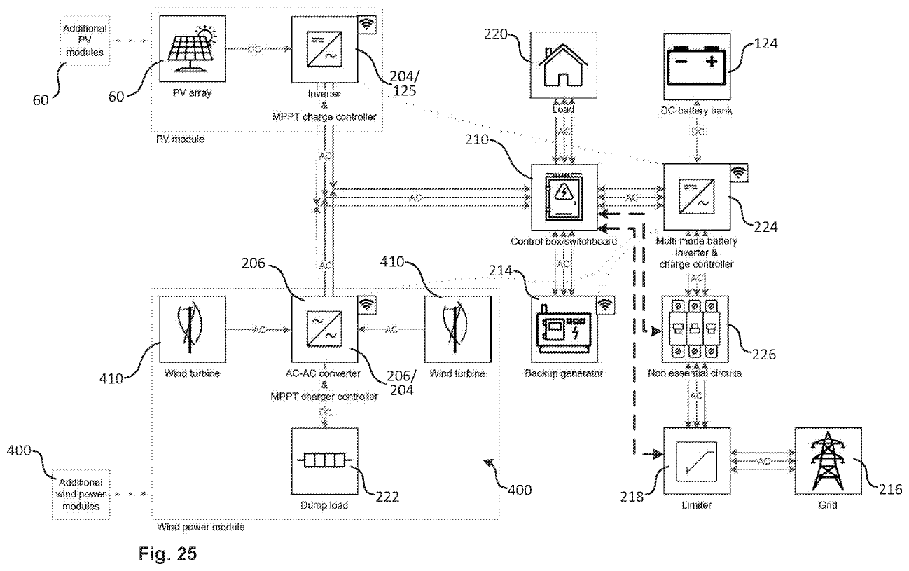

FIG. 25 is an alternate electrical schematic illustration of the EEMS 30 of the energy system 10, according to some embodiments. EEMS 30 comprises the solar panel array 60 electrical coupled to a maximum power point tracking module (MPPT) 204 and an inverter 125. The MPPT 204 may be a charge controller provided to maximise the output of the solar panel array 60, for example. In some embodiments, each of the at least one solar panel array 60 has an individual respective MPPT 204. In some embodiments, each of the at least one solar panel array 60 has an individual respective inverter 125.

The MPPT 204 is electrically coupled to the inverter 125, wherein the MPPT 204 provides DC electricity to the inverter 125 to be converted to AC electricity. The inverter 125 converts DC electricity input and outputs AC electricity in line with the AC electricity used by the grid 216. This allows for the energy system 10 to be easily connected to the grid 216 at any location. In some embodiments, the grid 216 utilises 3-phase 400V AC electricity. The inverter 125 is electrically coupled to switchboard 210, and provides electrical power in line with grid 216 specifications.

In some embodiments, EEMS 30 further comprises at least one wind module 400 including at least one wind turbine 410 electrically coupled to an MPPT 204 and a converter 206. The MPPT 204 and the converter 206 are electrically coupled to a dump load 222 for discharging excess electrical power when required. The MPPT 204 may be a charge controller provided to maximise the output of the wind module 400, for example. The wind module 400 produces AC electricity that is not in line with the AC electricity of the grid 216. Converter 206 converts the AC electricity generated by wind module 400 to AC electricity in line with the AC electricity used by the grid 216. The converter 206 is electrically coupled to switchboard 210 and provides electrical power in line with grid 216 specifications.

In some embodiments, EEMS 30 further comprises energy storage subsystem 124, for storing electrical energy generated by the solar panel array 60 and/or the wind module 400. Energy storage subsystem 124 is coupled to switchboard 210 via a multimode battery inverter and charge controller 224. The multimode battery inverter and charge controller 224 inverts the AC electricity at the switchboard 210 to DC electricity suitable for the energy storage subsystem 124. The multimode battery inverter and charge controller 224 further controls current to the energy storage subsystem 124 to prevent or mitigate overload and/or damage to the energy storage subsystem 124.

In some embodiments, multimode battery inverter and charge controller 224 is in electrical communication with non-essential circuits 226. Non-essential circuits 226 may provide electrical energy to elements of energy system 10, such as lights 202, for example. Non-essential circuits 226 may further be in electrical communication with meter 218, and subsequently grid 216.

In some embodiments, non-essential circuits 226 are in direct electrical communication with switchboard 210 and not multimode battery inverter and charge controller 224. That is, non-essential circuits 226 directly connect to switchboard 210 rather than multimode battery inverter and charge controller 224, for example. In some embodiments, meter 218 is in direct electrical communication with switchboard 210 and not non-essential circuits 226. That is, meter 218, and subsequently 216, directly connect to switchboard 210 rather than non-essential circuits 226, for example.

Switchboard 210 further outputs AC electricity to loads 220 external to the energy system 10. Switchboard 210 may further receive AC electricity from generator 214, wherein the generator 214 is used when additional electrical power beyond the capability of the solar panel array 60 and/or the wind module 400 is required.

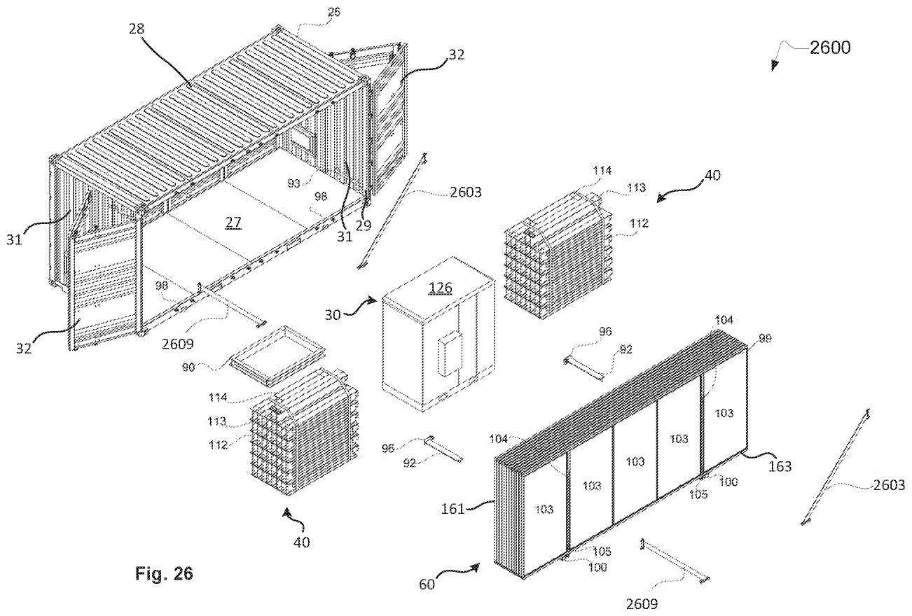

Referring to FIG. 26, there is shown a schematic illustration of an alternate modular energy generation system 2600, hereinafter referred to as an “energy system 2600”, in a disassembled configuration, according to some embodiments. Energy system 2600 is substantially similar to energy system 10, for example. Other than as noted herein, energy system 2600 is the same as energy system 10. In energy system 2600, the EEMS 30 comprises a singular integrated inverter and energy storage subsystem 126. That is, inverter 125 and the energy storage subsystem 124 are integrated into a singular system, being integrated inverter and energy storage subsystem 126, for example. The integrated inverter and energy storage subsystem 126 requires a single mount 90, configured to couple the integrated inverter and energy storage subsystem 126 to the storage frame 25.

Energy system 2600 may further include a plurality of supports 2609. Supports 2609 are removably couplable to the storage frame 25 to provide additional structural support to the storage frame 25, for example, during transport and movement of the energy system 2600. Energy system 2600 may include four supports 2609, for example. In some embodiments, two of the four supports 2609 are positioned within the storage frame 25 substantially proximal to the back portion and the other two of the four supports 2609 are positioned within the storage frame 25 substantially proximal to the front portion.

In some embodiments, energy system 2600 further includes at least two locking rails 93. Locking rails 93 are configured to receive at least one locking pin (not shown) for limiting movement of the solar panel array 60 relative to the locking rails 93. During transport or storage of the solar panel array 60 within the storage frame 25, locking pins may be inserted into the at least two locking rails 93 to limit movement of the solar panel array 60, for example. During deployment of the solar panel array 60, the locking pins may be removed from the at least two locking rails 93, for example.

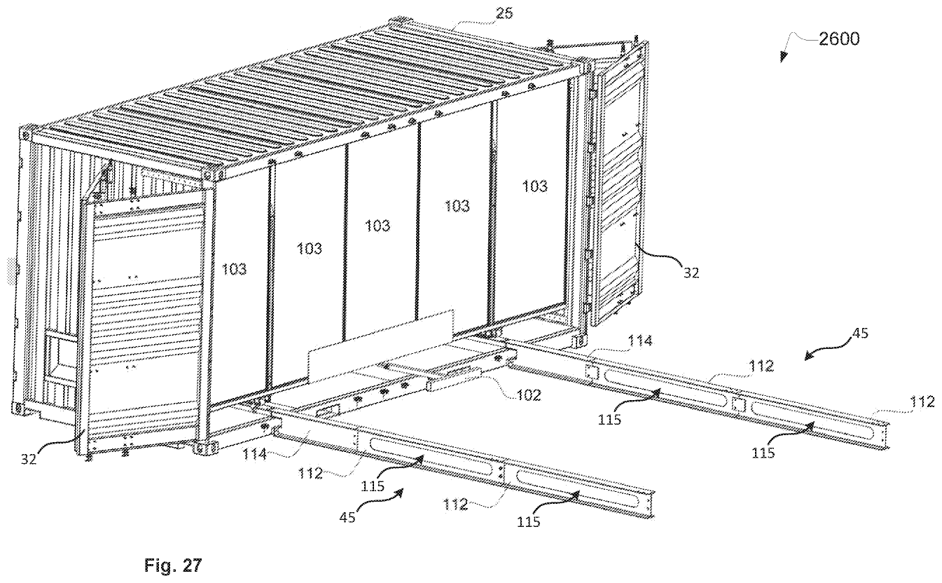

Referring to FIG. 27, there is shown a schematic illustration of the alternate modular renewable energy generation system 2600 in a partially deployed configuration, according to some embodiments. The partially deployed configuration of energy system 2600 is substantially similar to the partially deployed configuration of energy system 10 (shown in FIG. 17), for example. Energy system 2600 further comprises a T-shaped portion 102 for assisting in deployment of the solar panel array 60. The T-shaped portion 102 is releasably couplable to the last solar panel frame 163, such that it may be detached once the energy system 2600 is deployed.

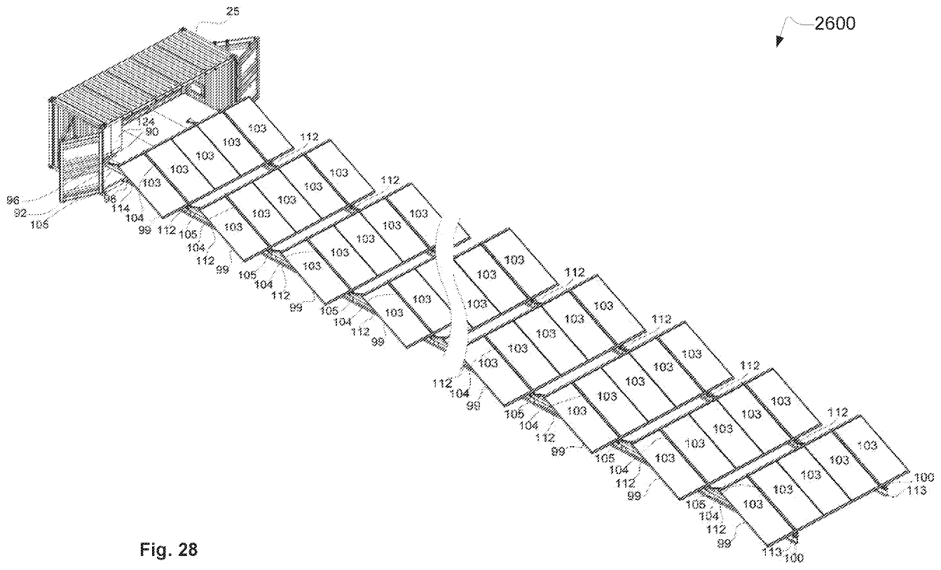

Referring to FIG. 28, there is shown a schematic illustration of the alternate modular renewable energy generation system 2600 in a deployed configuration, according to some embodiments. The deployed configuration of energy system 2600 is substantially similar to the deployed configuration of energy system 10 (shown in FIG. 18), for example. In contrast to energy system 10, to deploy the solar panel array 60 of energy system 2600, the external pulling force, such as a tractor, may be attached to the T-shaped portion 102. The external pulling force is then applied, pulling the last solar panel frame 163 via the T-shaped portion 102 along the composite rails in the manner as previously described in relation to FIG. 18.

Referring to FIG. 29, there is shown a schematic illustration of a means of coupling the solar panel frame 99 to the intermediate rails 112 of energy system 2600, according to some embodiments. As exemplified in FIG. 29, each of the intermediate rails 112 of energy system 2600 include two slotted holes 2602. Each of the two slotted holes 2602 of each intermediate rail 112 are configured to receive an end of a respective retention mechanism, such as a U-bracket 2604 as shown. The retention mechanism is configured to limit movement of the respective solar panel frame 99 with respect to the intermediate rail 112 via insertion into the two slotted holes 2602. For example, the U-bracket 2604 is configured to overlay the wheel 100 of each solar panel frame 99 and slot into the two slotted holes 2602 of the intermediate rails 112, limiting movement of the respective solar panel frame 99. That is, the U-bracket 2604 locks each solar panel frame 99 to a respective intermediate rail 112 by limiting movement of the wheel 100 of the solar panel frame 99, for example.

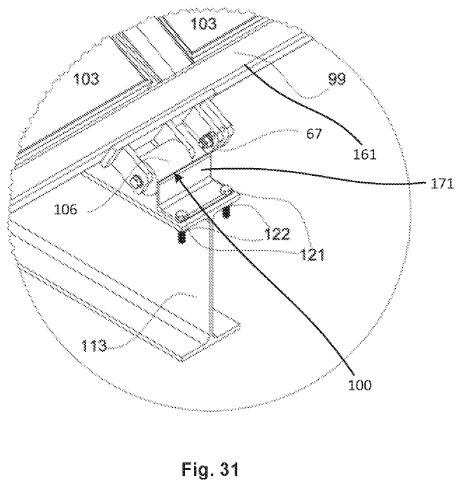

Referring to FIG. 30, there is shown a schematic illustration of an alternate means of coupling the first solar panel frame 161 of energy system 2600 to the storage frame, according to some embodiments. The means of coupling exemplified in FIG. 30 may be substantially similar to the means of coupling exemplified in FIG. 10, for example. That is, the at least one connection bracket 66 is received by the at least one bracket 96 of the storage frame 25 and coupled to one another via a coupling member 95, as shown in FIG. 30, for example.

Referring to FIG. 31, there is shown a schematic illustration of the end rail 113 of the modular renewable energy generation system 2600 in a deployed configuration, according to some embodiments. The end rail 113 of energy system 2600 is substantially similar to the end rail 113 of energy system 10, for example. As shown in FIG. 31 and as previously described in relation to FIG. 20, the last solar panel frame 113 each end rail 113 includes a stopper 171 configured to prevent or limit translational movement of the solar panel array 60 further than the composite rails 45. That is, stopper 171 prevents/limits the solar panel array 60 from rolling, via the wheel sets 100, off of the composite rails 45, as shown in FIG. 31, for example. Stopper 171 may be coupled to the end rail via a plurality of bolts 121 and corresponding nuts 122.

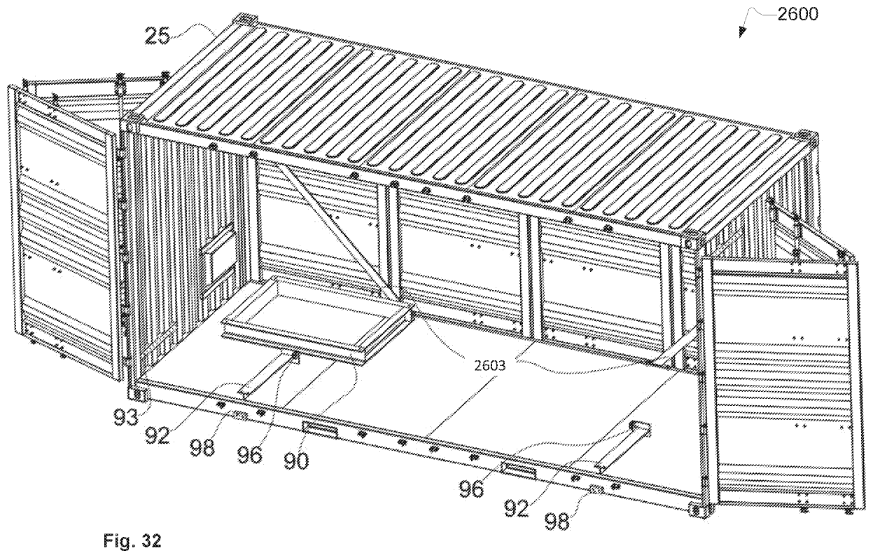

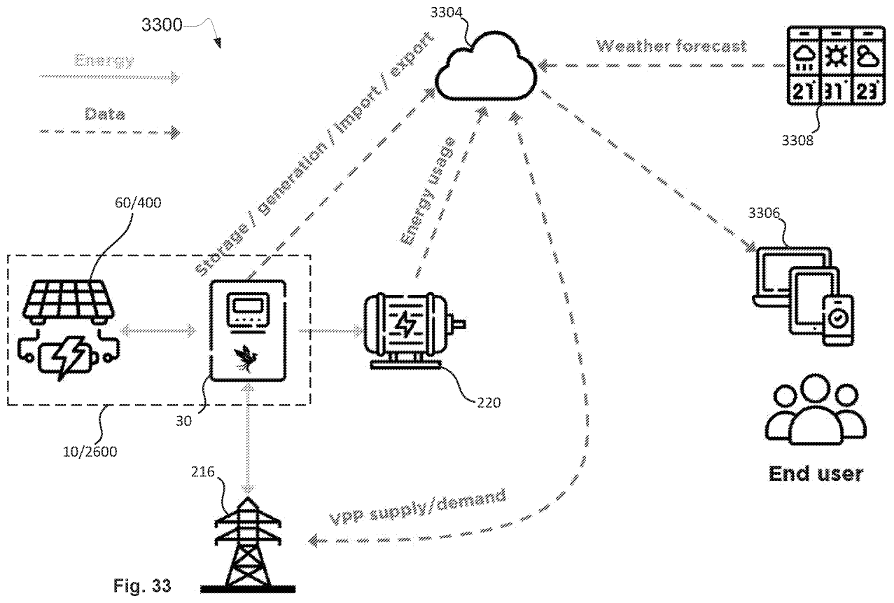

FIG. 32 is a front side perspective view of the storage frame 25 of energy system 2600 in an open configuration, according to some embodiments. Energy system 2600 may further comprise a plurality of supporting members 2603 for increasing the structural integrity of the storage frame 25. The plurality of supporting members 2603 may also assist in preventing or limiting movement of the various components of energy system 2600, such as the solar panel array 60, during storage and transportation. The plurality of supporting members 2603 are releasably couplable to the storage frame 25, such that they may be individually removed from therefrom. For example, during deployment of the energy system 2600, one or more of the plurality of supporting members 2603 may be decoupled from the storage frame 25 to allow the solar panel array 60 to be deployed as previously described.

Referring to FIG. 33, there is a process flow diagram of a smart system 3300 utilising energy system 10 or energy system 2600. In the smart system 3300, the energy system 10, 2600 is configured to communicate with the database 3304 via the EEMS 30. The database 3304 may be hosted on the cloud, for example. The EEMS 30 may be configured to provide to the database 3304 electrical energy information, such as, but not limited to, electrical energy storage data, electrical energy generation data, electrical energy import data, and electrical energy export data, for example.

In some embodiments, energy system 10, 2600 is in electrical communication with loads 220, as previously described. The EEMS 30 may further provide energy information relating to the electrical energy usage of the loads 220 to the database 3304. In some embodiments, energy system 10, 2600 is in electrical communication with grid 216, as previously described. The EEMS 30 may further provide energy information relating to import and/or export of electrical energy from/to the grid 216 to the database 3304. Database 3304 may further be in communication with external information sources, such as weather data providers 3308, to obtain information such as weather forecasts or historical weather condition data.

In some embodiments, database 3304 hosts one or more webapps accessible to one or more users via user devices 3306. The one or more webapps may display key information relating to the energy system 10, 2600, such as the electrical energy information provided to the database 3304, electrical energy usage of connected loads 220, import/export of electrical energy from/to the grid 216, and or specific weather conditions at the location at which the energy system 10, 2600 is deployed.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A modular solar power generation system, including:
a transportable storage frame defining a base, a roof, opposite side walls, an interior space having an openable front portion and a back portion;
a first rail and a second rail coupled to the storage frame and extending from the front portion;
an electrical energy management subsystem housed in the storage frame;
a plurality of solar panels frames, wherein the solar panel frames are configured to extend from the storage frame in a concertina-like configuration along the first and second rails;
a plurality of solar panels coupled to each of the plurality of solar panel frames, wherein the solar panels are configured to generate energy to be stored in an energy storage system;
electrical cabling for electrically coupling an electrical output from the plurality of solar panels to the electrical energy management subsystem; and
a panel angle adjustment mechanism coupled to the solar panel frames for adjustment of a panel angle of the solar panel frames.

2. The system of claim 1, wherein the solar panels on the plurality of the solar panel frames are electrically coupled in series.

3. The system of claim 1 or claim 2, wherein the solar panels are electrically coupled in multiple groups, wherein the solar panels of each group are electrically coupled in series, and wherein the multiple groups are electrically coupled to the electrical energy management subsystem (EEMS) in parallel.

4. The system of claim 3, wherein each group of solar panels is coupled to multiple solar panel frames.

5. The system of claim 3 or claim 4, wherein each group includes 2 to 4 solar panel frames.

6. The system of any one of claims 1 to 5, wherein each solar panel frame is mechanically coupled to at least another one of the plurality of solar panel frames.

7. The system of any one of claims 1 to 6, wherein each solar panel frame has first and second base mounting parts to slideably mount each solar panel frame on the first and second rails, respectively.

8. The system of claim 7, wherein each of the first and second base mounting parts includes a side retention flange for retaining the first and second base mounting parts on the first and second rails during sliding movement of the solar panel frames relative to the first and second rails.

9. The system of claim 7 or claim 8, wherein the first and second base mounting parts include at least one wheel for rolling along a top surface of a respective one of the first and second rails.

10. The system of any one of claims 1 to 9, further including an energy storage subsystem electrically coupled to the EEMS to store electrical energy received from the solar panels.

11. The system of claim 10, wherein the energy storage subsystem is mounted to the base in the interior space.

12. The system of any one of claims 1 to 11, wherein the EEMS is mounted to the base or a side wall inside the interior space.

13. The system of any one of claims 1 to 12, wherein a proximal portion of each of the first and second rails extends inwardly of the storage frame.

14. The system of any one of claims 1 to 13, wherein a most proximal one of the plurality of solar panel frames is coupled to the base adjacent a proximal end of each of the first and second rails.

15. The system of any one of claims 1 to 14, wherein each of the first and second rails has a distal end and a stopper affixed to the respective distal end to limit movement of a most distal one of the solar panel frames.

16. The system of any one of claims 1 to 15, wherein the openable front portion includes a pair of doors hinged to rotate from a closed position, in which the doors cover the front portion, to an open position, in which the doors are rotated toward the side walls and the storage frame defines a front opening.

17. The system of claim 16, wherein each of the doors has a first panel hingedly coupled to a second panel, and the second panel is hingedly coupled to a stanchion of the storage frame.

18. The system of any one of claims 1 to 17, wherein the front opening is sized to permit movement of the solar panel frames therethrough.

19. The system of any one of claims 1 to 18, wherein the solar panel frames are receivable in the interior space in a stowed configuration in which the solar panel frames are stacked together so that each solar panel frame is vertically orientated.

20. The system of any one of claims 1 to 19, wherein the solar panel frames define a cable slot for receiving at least part of the electrical cabling coupled to the solar panel carried by the respective solar panel frame.

21. The system of any one of claims 1 to 20, wherein each solar panel frame includes an adjustable beam for adjustment of the panel angle of the solar panel frame.

22. The system of claim 21, wherein the adjustable beam supports the solar panel frame.

23. The system of any one of claims 1 to 22, wherein the first rail and the second rail each have a length of between 50 m to 100 m.

24. The system of any one of claims 1 to 23, wherein the system has a weight of between 17,000 kg and 30,000 kg.

25. The system of any one of claims 1 to 24, wherein the storage frame has a length of between 6 m to 13 m.

26. The system of any one of claims 1 to 25, wherein the storage frame has a width of between 2 m to 3 m.

27. The system of any one of claims 1 to 26, wherein the storage frame has a height of between 2.4 m to 3.3 m.

28. The system of claim 7 or any one of claims 9 to 27 when dependent on claim 7, further including a plurality of retention mechanisms to couple each solar panel frame with the first and second rails to limit movement of each respective solar panel frame with respect to the first and second rails.
